(19) United States
(12) Patent Application Publication
(10) Pub. No.: US 2010/0006439 A1
(43) Pub. Date: Jan. 14, 2010

(54) METHODS AND APPARATUS FOR MANIPULATION AND/OR DETECTION OF BIOLOGICAL SAMPLES AND OTHER OBJECTS

(75) Inventors: Donhee Ham, Cambridge, MA (US); Robert Westervelt, Lexington, MA (US); Thomas Hunt, Portland, OR (US); Yong Liu, Cambridge, MA (US); Hakho Lee, Cambridge, MA (US)

Correspondence Address: WOLF GREENFIELD & SACKS, P.C., 600 ATLANTIC AVENUE, BOSTON, MA, 02210-2206, US

(73) Assignee: President and Fellows of Harvard College, Cambridge, MA (US)

(21) Appl. No.: 12/559,895

(22) Filed: Sep. 15, 2009

Related U.S. Application Data
(63) Continuation of application No. 11/105,322, filed on Apr. 13, 2005, now abandoned.
(60) Provisional application No. 60/561,704, filed on Apr. 13, 2004.
(60) Provisional application No. 60/611,370, filed on Sep. 20, 2004.
(60) Provisional application No. 60/627,940, filed on Nov. 15, 2004.

(51) Int. Cl. B03C 5/02

(52) U.S. Cl. 204/547; 204/643

(57) ABSTRACT

Methods and apparatus for manipulation, detection, imaging, characterization, sorting and/or assembly of biological or other materials, involving an integration of CMOS or other semiconductor-based technology and microfluidics. In one implementation, various components relating to the generation of electric and/or magnetic fields are implemented on an IC chip that is fabricated using standard protocols. The generated electric and/or magnetic fields are used to manipulate and/or detect one or more dielectric and/or magnetic particles and distinguish different types of particles. A microfluidic system is fabricated either directly on top of the IC chip, or as a separate entity that is then appropriately bonded to the IC chip, to facilitate the introduction and removal of cells in a biocompatible environment, or other particles/objects of interest suspended in a fluid. The patterned electric and/or magnetic fields generated by the IC chip can trap and move biological cells or other objects inside the microfluidic system. Electric and/or magnetic field generating components also may be controlled using signals of various frequencies so as to detect one or more cells, particles or objects of interest, and even the type of particle or object of interest, by measuring resonance characteristics associated with interactions between samples and one or more of the field-generating devices. Such systems may be employed in a variety of biological and medical related applications, including cell sorting and tissue assembly.

### CROSS-REFERENCES TO RELATED APPLICATIONS

This application claims the benefit under 35 U.S. C §120 as a continuation of U.S. patent application Ser. No. 11/105,322, filed Apr. 13, 2005, entitled “Methods and Apparatus for Manipulation and/or Detection of Biological Samples and Other Objects.”

U.S. patent application Ser. No. 11/105,322 also claims the benefit, under 35 U.S.C. §119(e), the following U.S. provisional applications:

Ser. No. 60/561,704, filed Apr. 13, 2004, entitled “Programmable Integrated Biochip;”

Ser. No. 60/611,370, filed Sep. 20, 2004, entitled “An I/C Microfluidic Hybrid Microsystem for 2D Magnetic Manipulation of Individual Biological Cells;” and

Ser. No. 60/627,940, filed Nov. 15, 2004, entitled “Methods and Apparatus for Manipulation and/or Detection of Biological Samples and Other Objects.”

Each of the foregoing applications is hereby incorporated herein by reference.

### GOVERNMENT SPONSORED RESEARCH

Some of the research relating to the subject matter disclosed herein was sponsored by the following government grants, and the government has certain rights to some disclosed subject matter: NSF-PHY-0117795, NSF-DMR-98-09363, NSF-PHY-9871810, NSF-DMR-98-02242, DARPA-DAAD 19-01-1-0659, ONR-N00014-95-1-0104, and ONR-N00014-99-1-0347.

### FIELD OF THE DISCLOSURE

The present disclosure relates generally to methods and apparatus for manipulating, detecting, imaging, and/or identifying particles or objects via electromagnetic fields. In various examples, integrated microsystem methods and apparatus are disclosed, involving electric and/or magnetic field-generating devices fabricated using conventional semiconductor techniques (e.g., Si, SiGe, CMOS, GaAs, InP) and configured to direct, sense, image, and/or identify particles or objects of interest via electric and/or magnetic field interactions. In some examples, such field-generating devices are integrated together with a microfluidic system to further facilitate movement, sensing, imaging and/or identification of particles or objects of interest.

### BACKGROUND

In biological and medical sciences, it is often useful to be able to manipulate (e.g., move or direct) a biological sample (e.g., one or more cells) along a prescribed path. Manipulation of biological systems based on magnetic fields is one conventionally used method to accomplish this task. In one conventional implementation involving magnetic fields, a small magnetic bead with a chemically modified surface can be coupled to a target biological system, such as a particular cell or microorganism. Depending on the type of coating of a given bead, and the relative sizes of the bead and the target cell or microorganism, the bead may be bound to the surface of the cell or organism (exterior coupling), or ingested by the cell or organism (interior coupling). Such a “bead-bound” sample then may be suspended in a host liquid to constitute a “microfluid,” and the suspended sample in the microfluid can then be manipulated using an external magnetic field. Devices based on this principle often are referred to as “magnetic tweezers” and have been conventionally used, for example, to trap small particles (e.g., DNA) suspended in a liquid for study.

Because magnetic fields and the magnetic beads themselves are typically biocompatible, this process is non-invasive and generally not damaging to the sample. However, conventional magnetic tweezers fail to provide individual control of multiple magnetic beads because these devices typically produce only a single field peak that may be moved; thus only a single bead or, simultaneously, a group of beads in close proximity, may be conventionally controlled within a microfluid.

Another area related to the movement and manipulation of biological samples, particles, or other objects suspended in liquid involves a phenomenon referred to as “dielectrophoresis.” Dielectrophoresis occurs when an inhomogeneous electric field induces a dipole on a particle suspended in liquid. The subsequent force on the dipole pulls the particle to either a minimum or a maximum of the electric field. Almost any particle, without any special preparation, can be trapped or moved using dielectrophoresis when it is exposed to the proper local electric field. This is an advantage of electric field-based operation over the magnetic field-based manipulation described above, as the latter mandates marking biosamples or other objects of interest with magnetic beads. However, a potential disadvantage of the dielectrophoresis is that a relatively strong electric field may damage the cell, particle or other object of interest in some circumstances.

Yet another area related to the movement and manipulation of biological samples that enables various applications in medical diagnostics and life sciences is referred to as “microfluidics.” Microfluidics is directed to the containment and/or flow of small biological samples by providing a micro-scale biocompatible environment that supports and maintains physiological homeostasis for cells and tissues. Microfluidic systems may be configured as relatively simple chambers or reservoirs (“bathtubs”) for holding liquids containing cells/biological samples of interest; alternatively, such systems may have more complex arrangements including multiple conduits or channels in which cells, particles, or other objects of interest may flow. By controlling the flow of fluids in micro-scale channels, a small quantity of samples can be guided in desired pathways within a microfluidic system. Integration of various microfluidic devices, such as valves, filters, mixers, and dispensers, with microfluidic channels in a more complex microfluidic system facilitates sophisticated biological analysis on a micro-scale. Fabrication of even some complex conventional microfluidic systems generally is considered to be cost-effective, owing to soft-lithography techniques that allow many replications for batch fabrication.

Once fabricated, however, conventional microfluidic systems (especially more complex systems) do not offer an appreciable degree of flexibility, and specifically suffer from insufficient programmability and controllability. In particular, conventional microfluidic systems that are used for analytic operations such as cell sorting are manufactured to have a specific number and arrangement of fixed channels and valves. Operation of the valves controls the flow of cells into the channels, thereby sorting them. Function of the system generally is based on a statistical approach of differentiating amongst relatively larger numbers of cells, and not sorting one cell at a time. Because the arrangement of channels and valves is determined during fabrication of the microfluidic system, each system is designed for a specific operation and typically cannot be used in a different process without modifying its basic structure.

Integrated circuit (IC) technology is one of the most significant enabling technologies of the last century. IC technology is based on the use of a variety of semiconductor materials (e.g., Silicon Si, Silicon Germanium SiGe, Gallium Arsenide GaAs, Indium Phosphide InP, etc.) to implement a wide variety of electronic components and circuits. Perhaps one of the most prevalent examples of IC technology is CMOS (Complimentary-Metal-Oxide-Semiconductor) technology, with which silicon integrated circuits are fabricated.

CMOS technology is what made possible advanced computation and communication applications that are now a routine part of everyday life, such as personal computers, cellular telephones, and wireless networks, to name a few. The growth of the computer and communication industry has significantly relied upon continuing advances in the electronic and related arts in connection with reduced size and increased speed of silicon integrated circuits, whose trend is often quantified by Moore's law. Currently, silicon CMOS chips can contain over 100 million transistors and operate at multi-gigahertz (GHz) speeds with structures as small as 90 nanometers. CMOS microfabrication technology has matured significantly over the last decades, making silicon integrated circuits very inexpensive. Despite several advantages, however, neither CMOS nor any other semiconductor-based IC technology has been widely used (i.e., beyond routine data processing functions) to implement structures for biological applications such as sample manipulation and characterization.

### SUMMARY

Applicants have recognized and appreciated that integrated circuit semiconductor-based technology (e.g., Si, SiGe, GaAs, InP, etc.), and especially CMOS technology, provides a viable foundation for the realization of systems and methods for manipulating and characterizing biological materials and other objects of interest. Furthermore, Applicants have recognized and appreciated that by combining CMOS or other semiconductor-based technology with microfluidics, a wide variety of useful and powerful methods and apparatus relating to biological and other materials may be realized.

In view of the foregoing, various embodiments of the present disclosure are directed to methods and apparatus for one or more of manipulation, detection, imaging, characterization, sorting and assembly of biological or other materials on a micro-scale, involving an integration of CMOS or other semiconductor-based technology and microfluidics.

For example, one embodiment is directed to an IC/microfluidic hybrid system that combines the power of an integrated circuit chip with the biocompatibility of a microfluidic system. In one aspect of this embodiment, various components relating to the generation of electric and/or magnetic fields of such a hybrid system are implemented on an IC chip that is fabricated using standard protocols (e.g., CMOS) in a chip foundry. In another aspect, the field generating components themselves may be formed using standard CMOS protocols and hence do not require any micromachining techniques (e.g., as in micro-electro-mechanical structures, or MEMS implementations). The electric and/or magnetic fields generated from such an IC chip may be used to manipulate and/or detect one or more dielectric and/or magnetic particles and distinguish different types of particles.

In particular, in one embodiment, an array of microelectromagnets, or “microcoils,” are implemented on an IC chip and configured to produce controllable spatially and/or temporally patterned magnetic fields. In one aspect, the IC chip also may include a programmable digital switching network and one or more current sources configured to independently control the current in each microcoil in the array so as to create the spatially and/or temporally patterned magnetic fields. In another aspect, the IC chip may further include a temperature regulation system to facilitate biocompatibility of the hybrid system.

In another embodiment, an array of microelectrodes, or “microposts,” are implemented on an IC chip and configured to produce controllable spatially and/or temporally patterned electric fields to manipulate particles of interest based on dielectrophoresis principles. In one aspect, the IC chip also may include a programmable digital switching network and one or more voltage sources configured to independently control the voltage across each micropost in the array so as to create the spatially and/or temporally patterned electric fields. As in the previous embodiment, in another aspect, the IC chip may further include a temperature regulation system to facilitate biocompatibility of the hybrid system.

In yet another embodiment, an array of microcoils implemented on an IC chip may be configured to produce both controllable, spatially and/or temporally patterned, electric fields and/or magnetic fields. In one aspect, the IC chip also may include a programmable digital switching network, together with one or more current sources and one or more voltage sources, configured to independently control the current in and voltage across each microcoil in the array to create the spatially and/or temporally patterned magnetic fields and electric fields. In another aspect of this embodiment, the microcoils effectively act as microposts when a voltage is applied across them, thereby functioning to manipulate particles of interest based on dielectrophoresis principles as in the previous embodiment. Again, the IC chip according to this embodiment may further include a temperature regulation system to facilitate biocompatibility of the hybrid system.

In connection with any of the foregoing embodiments related to electric and/or magnetic field generation, according to yet another embodiment of the present disclosure, a microfluidic system may be fabricated either directly on top of the IC chip, or as a separate entity that is then appropriately bonded to the IC chip, to facilitate the introduction and removal of cells in a biocompatible environment, or other particles/objects of interest suspended in a fluid. In this manner, the patterned electric and/or magnetic fields generated by the IC chip can trap and move biological cells or other objects inside the microfluidic system.

Other embodiments of the present disclosure are directed to sensing/imaging methods and apparatus utilizing one of the IC-based magnetic and/or electric field generating arrays as introduced above, or other arrangements of magnetic and/or electric field-generating devices. For example, in various aspects of these sensing embodiments, a microcoil array, a micropost array, or other arrangement of field-generating devices (e.g., see the various structures described in PCT Application No. PCT/US02/36280, filed Nov. 5, 2002, entitled “System and Method for Capturing and Positioning Particles,” International Publication No. WO 03/039753 A1) may be controlled using signals of various frequencies so as to be capable of detecting one or more cells, particles or objects of interest, and even the type of particle or object of interest, by measuring resonance characteristics associated with interactions between samples and one or more of the field-generating devices.

In some embodiments, radio frequency (RF) signals are employed to facilitate detection, imaging and/or identification. One of the principles underlying these RF embodiments is that an RF field is capable of interacting with virtually any particle (biological or otherwise) that conducts electricity at the RF signal frequency, or is polarizable electrically or magnetically. Accordingly, in these RF sensing embodiments, the interaction between an RF field and an object in the vicinity of the RF field may be exploited to determine the position of one or more objects of interest so as to facilitate imaging of the object(s). In this manner, semiconductor-based/microfluidic hybrid systems and methods as disclosed herein may be configured to detect and image biological cells, particles and other objects of interest via purely electrical/magnetic means using RF signals, and without resorting to chemical agents or optical techniques. Based on such RF imaging techniques, various implementations of a hybrid system according to the present disclosure may incorporate feedback control mechanisms, whereby samples of interest may be manipulated based on acquired images of the samples.

In some aspects, the RF techniques disclosed herein may be used not only to detect and image particles, but also to identify different types of particles/objects of interest. This type of identification may be accomplished, for example, by measuring spectral responses of RF field/particle interactions over a broad range of frequencies and comparing these responses to known frequency dependent behavior of various materials in electromagnetic fields. In other aspects, RF techniques disclosed herein also may be used to conduct local measurements of magnetic resonance (including ferromagnetic resonance) in a uniform magnetic field applied to a sample or object of interest to thereby identify the material of the sample based on characteristic oscillating frequencies of spins (e.g., Electron Spin Resonance or “ESR”) or magnetic domains (e.g., Nuclear Magnetic Resonance or “NMR”). Accordingly, methods and apparatus according to various embodiments of the present disclosure may be employed to effectively implement a Magnetic Resonance Imaging (MRI) system on a chip.

In view of the manipulation, detection, imaging and identification techniques discussed above and in greater detail below, Applicants have recognized and appreciated that semiconductor-based/microfluidic hybrid systems and methods as disclosed herein facilitate a wide variety of new types of investigations in biomedicine and systems biology, as well as other applications.

For example, another embodiment of the present disclosure is directed to cell sorting methods and apparatus by employing IC/microfluidic hybrid methods and apparatus, as well as RF sensing/imaging methods and apparatus as introduced above. In one aspect, cell sorting methods and apparatus according to this embodiment facilitate molecularly-precise identification and rapid, highly-accurate sorting of cells. In particular, biological cells may be sorted individually with ultrahigh accuracy and with molecularly-precise identification. Such precision sorting facilitates the separation of specific (e.g., “rare”) cell types or pathogens (e.g., stem cells for bone marrow reconstitution procedures in cancer patients) for clinical applications. Such precision sorting also facilitates parsing a tissue's demographics and evaluating each cell type separately, rather than collecting gene expression data on tissue from an ensemble of different cell types.

Yet another embodiment of the present invention is directed to methods and apparatus for assembling micro-scale engineered tissues. In one aspect of this embodiment, a two-dimensional cell trap array based on an IC/microfluidic hybrid system is configured to be capable of micro-scale tissue assembly with precise control of cellular demographics and spatial distribution (e.g., artificial tissues from heterotypical distributions of cells may be assembled one cell at a time). Such a technique according to one embodiment of the present disclosure represents a new way to develop novel in vitro assays for studying communication networks amongst different cell types, drug efficacy, and for fundamental physiological study in a standardized, repeatable manner.

Semiconductor-based IC/microfluidic hybrid systems and methods according to various embodiments of the present disclosure have several important technological advantages. First, a semiconductor-based/microfluidic hybrid system may be fabricated in an appreciably cost-effective manner with high yield using a mature CMOS technology and inexpensive lithographic techniques for formation of the microfluidic system portion. Such CMOS implemented systems may be made significantly small in size and appropriately packaged to withstand various environmental hazards. Advanced low-power integrated circuit techniques also facilitate the fabrication of battery-powered devices. In view of the foregoing, such systems can be made as rugged single-use disposable devices, and may be employed in a variety of applications, including potentially adverse and/or emergency situations, that would otherwise be precluded using conventional methods and apparatus. For example, small, inexpensive, battery-powered, rugged hybrid systems according to various embodiments of the present disclosure may be easily and effectively employed in emergency medical situations to quickly screen an individual's health using saliva, breath, sweat, or blood samples. Such systems also may be employed to detect biologically harmful substances in a given environment.

Additionally, as compared to conventional magnetic manipulation methods using simple magnetic tweezers or external magnets, or conventional dielectrophoresis techniques, semiconductor-based/microfluidic hybrid systems and methods according to the present disclosure can manipulate single or multiple biological cells, particles or other objects of interest in a large quantity with easy, precise, and rapid control. Furthermore, semiconductor-based IC/microfluidic hybrid systems and methods according to various embodiments of the present disclosure offer significant flexibility over conventional microfluidic systems. In particular, somewhat more complex conventional microfluidic systems control biological samples in a fixed channel network using predetermined valve controls; hence, different operations require different specific microfluidic systems. In contrast, semiconductor-based/microfluidic hybrid systems and methods according to various embodiments of the present disclosure are capable of performing various and sophisticated cell/particle manipulation operations without necessarily requiring a complex microfluidic system structure.

For example, in one embodiment, a programmable hybrid system according to the present disclosure may be implemented using a relatively simple microfluidic system having only a single chamber (a “bathtub”) integrated with a semiconductor-based system that provides programmable and independently controllable electromagnetic fields. In this implementation, cells may be moved through the chamber along virtually any path under computer control of the electromagnetic fields. In this manner, the topology of a “virtual micro-scale plumbing system” for samples of interest may be flexibly changed for a wide variety of operations based on the programmability afforded by computer control. This provides an extremely powerful tool for precision cell/object manipulation in both relatively simple and more sophisticated operations.

In sum, one embodiment according to the present disclosure is directed to an apparatus, comprising a plurality of CMOS fabricated field-generating components, a microfluidic system configured to contain a fluid in proximity to the plurality of CMOS fabricated field-generating components, and at least one controller configured to control the plurality of CMOS fabricated field-generating components to generate at least one electric or magnetic field having a sufficient strength to interact with at least one sample suspended in the fluid.

Another embodiment according to the present disclosure is directed to a method, comprising an act of generating at least one electric of magnetic field from a plurality of CMOS fabricated field-generating components, the at least one electric or magnetic field having a sufficient strength to interact with at least one sample suspended in a fluid contained in a microfluidic system in proximity to the plurality of CMOS fabricated field-generating components.

The following references are incorporated herein by reference:

U.S. Non-provisional application Ser. No. 10/894,674, filed Jul. 19, 2004, entitled “Methods and Apparatus Based on Coplanar Striplines;”

U.S. Non-provisional application Ser. No. 10/894,717, filed Jul. 19, 2004, entitled “Methods and Apparatus Based on Coplanar Striplines;” and

PCT Application No. PCT/US02/36280, filed Nov. 5, 2002, entitled “System and Method for Capturing and Positioning Particles,” International Publication No. WO 03/039753 A1.

It should be appreciated that all combinations of the foregoing concepts and additional concepts discussed in greater detail below are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

FIG. 1 is a block diagram showing an overview of various components of a semiconductor-based/microfluidic hybrid system according to one embodiment of the present disclosure;

FIG. 2 illustrates an exemplary physical arrangement of components for the hybrid system shown in FIG. 1, according to one embodiment of the present disclosure;

FIGS. 3(a)-(d) illustrate a microelectromagnet wire matrix which provides one example of magnetic field-generating components that may be included in the hybrid system shown in FIGS. 1 and 2, according to one embodiment of the present disclosure;

FIG. 4 is a schematic illustration of a “ring trap” which also may serve as a magnetic field-generating component in the hybrid system shown in FIGS. 1 and 2, according to one embodiment of the present disclosure;

FIGS. 5(a) and (b) illustrate a micropost array which provides one example of electric field-generating components that may be included in the hybrid system shown in FIGS. 1 and 2, according to one embodiment of the present disclosure;

FIG. 6(a) is a conceptual perspective illustration of a microcoil array that may be employed as field-generating components in the hybrid system shown in FIGS. 1 and 2, according to one embodiment of the present disclosure;

FIG. 6(b) shows a conceptual illustration of a top (overhead) view of a portion of the array shown in FIG. 6(a), looking down to the array through a portion of a microfluidic channel that contains a liquid in which are suspended exemplary samples comprising a magnetic bead attached to a cell, according to one embodiment of the present disclosure;

FIGS. 7(a) and 7(b) show perspective and exploded views, respectively, of a multiple-layer microcoil that may be employed in the arrays of FIGS. 6(a) and (b), according to one embodiment of the present disclosure;

FIG. 8 conceptually illustrates a vertical layer structure of a portion of a CMOS IC chip showing the multiple-layer microcoil structure of FIGS. 7(a) and 7(b) in relation to other features and layers of the chip, according to one embodiment of the present disclosure;

FIG. 9 illustrates an exemplary magnetic field profile above a multi-layer microcoil similar to those illustrated in FIGS. 7 and 8 when a current flows through the microcoil, according to one embodiment of the present disclosure;

FIG. 10 conceptually illustrates two neighboring microcoils of the array shown in FIGS. 6(a) and (b), in which an essentially equal current flows through the microcoils to generate two essentially equal magnetic field peaks, according to one embodiment of the present disclosure;

FIGS. 11(a)-(e) show five exemplary scenarios for the neighboring microcoils of FIG. 10, with varying current magnitudes and directions in the respective coils and the resulting magnetic fields generated, according to one embodiment of the present disclosure;

FIG. 12 is a graph illustrating the current magnitude and direction in each of the coils for each of the five exemplary scenarios illustrated in FIGS. 11(a)-(e);

FIG. 13 shows a microcoil array similar to that shown in FIG. 6(a) and various field control components associated with the array, according to one embodiment of the present disclosure;

FIG. 14 shows various interconnections of components in a first quadrant of the array of FIG. 13, according to one embodiment of the present disclosure;

FIG. 15 illustrates the contents of a microcoil switching unit included in a microcoil cell of the first quadrant shown in FIG. 14, according to one embodiment of the present disclosure;

FIG. 16 illustrates details of a current source, according to one embodiment of the present disclosure, that provides current to the first quadrant shown in FIG. 14;

FIG. 17 illustrates an arrangement of RF/detection components that forms a “frequency locked loop,” according to one embodiment of the present disclosure, for facilitating sample detection;

FIG. 18 illustrates further details of a phase detector in the frequency locked loop shown in FIG. 17, according to one embodiment of the present disclosure;

FIG. 19 illustrates further details of a phase comparator of the phase detector shown in FIG. 18, according to one embodiment of the present disclosure;

FIG. 20 illustrates an alternative arrangement of RF/detection components for facilitating sample detection, according to another embodiment of the present disclosure;

FIG. 21 illustrates an arrangement of temperature regulation components according to one embodiment of the present disclosure;

FIGS. 22-26 illustrate various process steps involved in fabricating a polyimide-based microfluidic system as part of a hybrid system according to one embodiment of the present disclosure;

FIGS. 27-32 illustrate various process steps involved in fabricating a microfluidic system based on patterning of ultraviolet curable epoxy, according to one embodiment of the present disclosure;

FIGS. 33-38 illustrate various process steps involved in fabricating a microfluidic system based on soft lithography techniques, according to one embodiment of the present disclosure;

FIGS. 39(a)-(d) illustrate exemplary implementations of cell detection via RF sensing techniques as discussed above in connection with FIGS. 17-20, according to various embodiments of the present disclosure;

FIG. 40 illustrate a cell sorting apparatus based on the hybrid system of FIGS. 1 and 2, according to one embodiment of the present disclosure; and

FIGS. 41-43 illustrate a tissue assembly method using the hybrid system of FIGS. 1 and 2, according to one embodiment of the present disclosure.

### DETAILED DESCRIPTION

Following below are more detailed descriptions of various concepts related to, and embodiments of, methods and apparatus according to the present disclosure for one or more of manipulation, detection, imaging, characterization, sorting and assembly of biological or other materials. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

I. System Overview

One embodiment of the present disclosure is directed to a semiconductor-based/microfluidic hybrid system that combines the power of microelectronics with the biocompatibility of a microfluidic system. In some examples below, the microelectronics portion of the hybrid system is implemented in CMOS technology for purposes of illustration. It should be appreciated, however, that the disclosure is not intended to be limiting in this respect, as other semiconductor-based technologies may be utilized to implement various aspects of the microelectronics portion of the systems discussed herein.

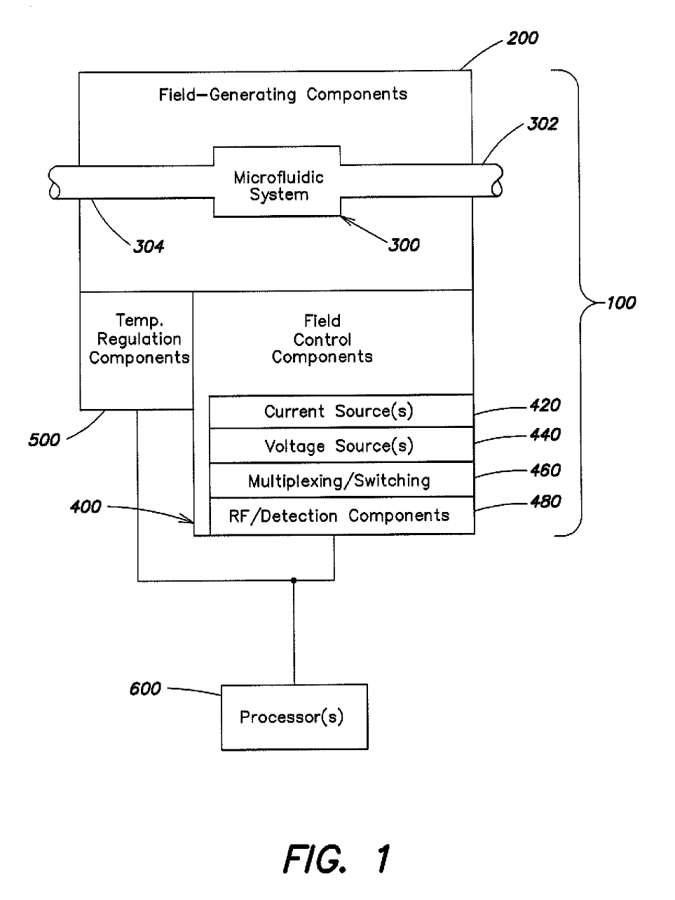

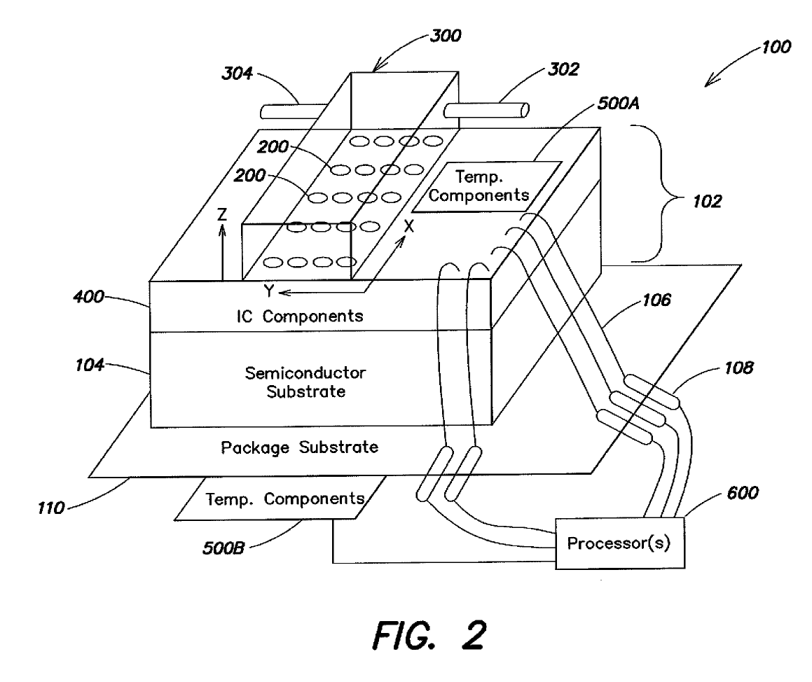

FIG. 1 is a block diagram showing a general overview of various components of a semiconductor-based/microfluidic hybrid system 100, and FIG. 2 illustrates an exemplary physical arrangement of components for such a system, according to one embodiment of the present disclosure. As illustrated in FIGS. 1 and 2, the hybrid system 100 comprises a microfluidic system 300 for holding liquids containing objects of interest (hereafter “samples”). The hybrid system also includes a number of other components, including electric and/or magnetic field-generating components 200, field control components 400, and temperature regulation components 500. In general, these other components may be employed to facilitate manipulation (e.g., trapping and/or moving), detection, imaging and/or identification of samples via electric and/or magnetic fields, including biological samples requiring regulation of environmental conditions (e.g., temperature).

In one aspect of this embodiment, as shown in FIG. 2, some or all of these other components of the hybrid system 100 may be implemented as one or more integrated circuit (IC) chips 102 using various semiconductor fabrication techniques. For example, FIG. 2 illustrates that various field-generating components 200, field control components 400, and temperature components 500 may be fabricated on a semiconductor substrate 104, pursuant to any of a variety of semiconductor fabrication techniques, to form an IC chip 102. As mentioned above and discussed in greater detail below, one exemplary implementation of such an IC chip may be fabricated using standard CMOS protocols. The IC chip 102 further may be mounted on a package substrate 110, and bonding wires 106 and contacts (e.g., pins) 108 may be employed to facilitate electrical connections to the IC chip 102. In one embodiment discussed further below, the field control components 400 also may include various components to facilitate wireless communication of data and control signals to and from the IC chip 102.

FIGS. 1 and 2 also illustrate one or more processors 600 configured to control the various components of the hybrid system 100 to facilitate manipulation of samples contained in (or flowing through) the microfluidic system 300. The one or more processors 600 also may be configured to perform various signal processing functions to facilitate one or more of detection, imaging and identification of samples. It should be appreciated that in various configurations, the one or more processors 600 may be implemented as separate components from the hybrid system 100, and optionally located remotely from the hybrid system, as shown in FIG. 2 (e.g., a variety of conventional computing apparatus may be coupled to the hybrid system via one or more contacts 108, or via wireless communications). Alternatively, some or all of the processor functionality may be implemented by elements integrated together with other components in one or more IC chips 102 that form part of the hybrid system 100.

In the hybrid system 100, according to one embodiment, the microfluidic system 300 may be configured as a relatively simple chamber or reservoir for holding liquids containing samples of interest. For example, as illustrated generically in FIGS. 1 and 2, a microfluidic reservoir having an essentially rectangular volume may include access conduits 302 and 304 to facilitate fluid flow into and out of the reservoir. Alternatively, the microfluidic system may have a more complex arrangement including multiple conduits or channels in which liquids containing samples may flow, as well as various components (e.g., valves, mixers) for directing flow. In various embodiments, the microfluidic system 300 may be fabricated on top of an IC chip 102 containing other system components, once the semiconductor fabrication processes are completed, to form the hybrid system 100; alternatively, the microfluidic system 300 may be fabricated separately (e.g., using soft lithography techniques) and subsequently attached to one or more IC chips containing other system components to form the hybrid system 100. Further details regarding the microfluidic system 300 are discussed below in Section V.

In other aspects of the embodiment shown in FIG. 1, the electric and/or magnetic field-generating components 200 of the hybrid system 100 may be disposed with respect to the microfluidic system 300 in a variety of arrangements so as to facilitate interactions between generated fields and samples contained in (or flowing through) the microfluidic system. In various implementations, the field-generating components 200 may be disposed proximate to the microfluidic system along one or more physical boundaries of the microfluidic system and arranged so as to permit field-sample interactions along one or more spatial dimensions relative to the microfluidic system.

For example, in one implementation, as illustrated in FIG. 2, the microfluidic system 300 may be configured as an essentially rectangular-shaped reservoir above an IC chip 102 that contains a two-dimensional array of field-generating components 200 disposed in a plane proximate to and essentially parallel to a floor of the reservoir. Such an arrangement facilitates manipulation of samples generally along two dimensions defining a plane parallel to the floor of the reservoir (indicated by x-y axes in FIG. 2). In another implementation, field-generating components may alternatively or additionally be disposed along one or more sides of such a reservoir to facilitate manipulation of samples along a third dimension transverse (e.g., perpendicular) to the floor of the reservoir (indicated by a z axis in FIG. 2). In yet another implementation, a reservoir may be “sandwiched” between two arrays of field-generating components respectively contained in IC chips disposed above and below the reservoir. In such an arrangement, the multiple arrays of field-generating components may be controlled such that three-dimensional manipulation of samples may be accomplished. Additionally, various arrangements of field-generating components with respect to the microfluidic system may facilitate rotation of samples.

It should be appreciated that the foregoing exemplary arrangements are provided primarily for purposes of illustration, and that a variety of arrangements of a microfluidic system and field-generating components (including linear or two-dimensional arrays of field-generating components, or other arrangements of discrete field generating components) are contemplated according to other embodiments to provide multi-dimensional manipulation of samples. In general, according to the various concepts discussed herein, samples of interest may be moved through the microfluidic system along virtually any path, trapped or held at a particular location, and in some cases rotated, under computer control of the electric and/or magnetic fields generated by the field-generating components 200. In this manner, the topology of a “virtual micro-scale plumbing system” for samples of interest may be flexibly changed for a wide variety of operations based on the programmability and computer control afforded, for example, by the processor(s) 600. This provides an extremely powerful tool for precision cell/object manipulation in both relatively simple and more sophisticated operations.

In various embodiments of the hybrid system 100 shown in FIGS. 1 and 2, the field-generating components 200 may be configured to generate electric fields, magnetic fields, or both. For example, in one embodiment, the field-generating components are configured and operated to produce controllable spatially and/or temporally variable magnetic fields that extend into the microfluidic system. The magnetic fields thusly generated interact with magnetic samples suspended inside the microfluidic system, examples of which include, but are not limited to, biological cells attached to magnetic beads (“bead-bound cells”). With respect to biological samples, it is noteworthy that the magnetic fields do not damage cells; rather, as discussed above, cell manipulation and identification via magnetic fields is a commonly used technique to molecularly identify a biological cell by a specific, ligand-coated magnetic bead. As discussed in further detail below, the interaction between the spatially and/or temporally variable magnetic fields and bead-bound cells or other magnetic samples enables trapping, transport, detection and imaging of single or multiple magnetic samples.

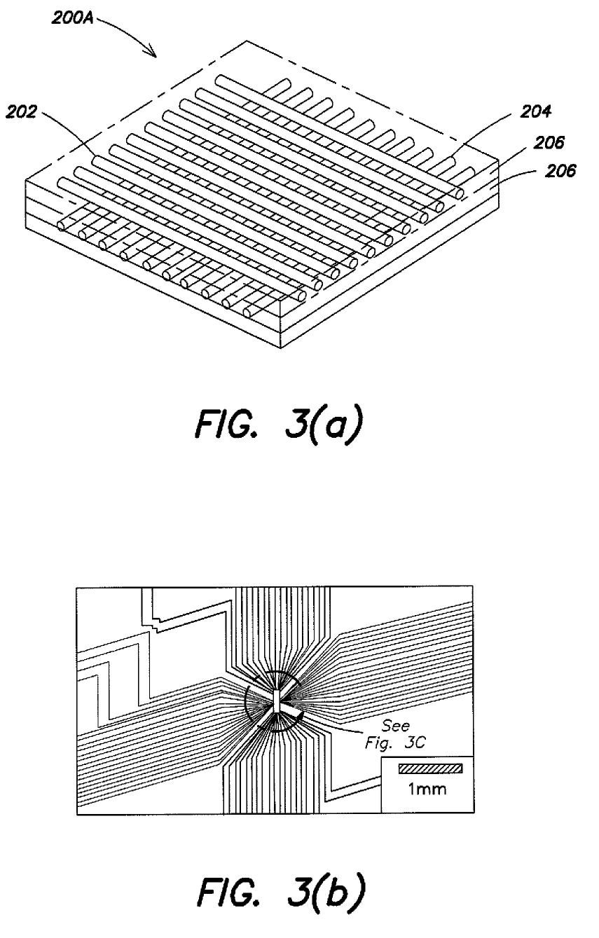

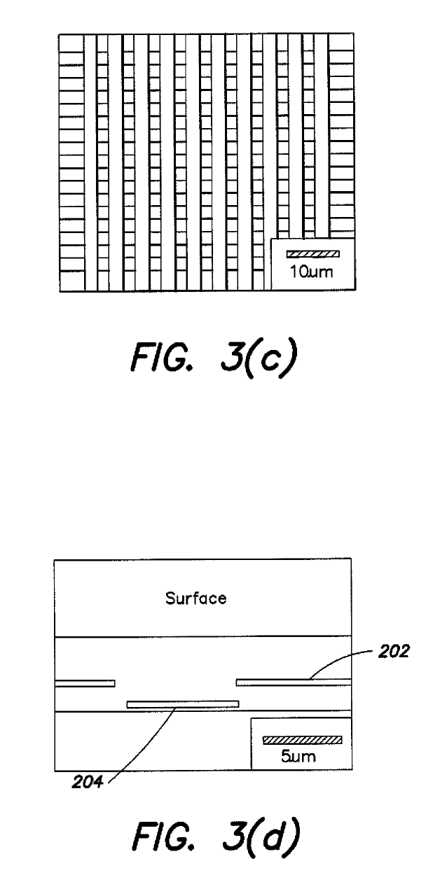

Examples of magnetic field-generating components 200 that may be included in the hybrid system 100 shown in FIGS. 1 and 2 include, but are not limited to, a two-dimensional microelectromagnet wire matrix, as illustrated in FIGS. 3(a)-(d), as well as one or more “ring traps,” as illustrated in FIG. 4. These exemplary components are discussed in detail in PCT Application No. PCT/US02/36280, filed Nov. 5, 2002, entitled “System and Method for Capturing and Positioning Particles,” International Publication No. WO 03/039753 A1, incorporated herein by reference.

FIG. 3(a) is a schematic illustration of a microelectromagnet wire matrix 200A. According to one embodiment, the matrix comprises a top layer 202 and a bottom layer 204 of essentially straight conductors (e.g., gold or other metal wires or traces), wherein each layer is covered by an insulating layer 206 (e.g., polyimide) and the conductors of the respective layers are disposed in a transverse manner (e.g., the conductors of the top layer are perpendicular to the conductors of the bottom layer). In different implementations, this structure may be fabricated on a variety of substrates, one example of which includes a sapphire substrate. FIG. 3(b) illustrates a micrograph of such a fabricated wire matrix including electrical attachment leads, where an exemplary scale for the depicted fabricated device is indicated in the legend at the bottom right of the figure. FIG. 3(c) shows a magnified portion of the device shown in FIG. 3(b), which essentially corresponds to the conceptual depiction of FIG. 3(a). Finally, FIG. 3(d) is a micrograph of a cross-sectional view of the device, illustrating the vertical two-layer conductor/insulator structure.

In one embodiment based on the wire matrix shown in FIGS. 3(a)-(d), each conductor in the wire matrix (or alternatively predetermined groups of conductors) may be connected to a controllable current source (discussed further below) so that all conductors (or groups of conductors) can have independent current flows. By independently modulating the magnitude of the currents in the conductors, various dynamic magnetic field patterns can be produced in proximity to (e.g., above) the wire matrix. For example, the currents can be controlled such that the wire matrix can create a single magnetic peak that is moving continuously, multiple peaks with each peak controlled independently, or varying magnetic fields to rotate or twist a target sample.

FIG. 4 is a schematic illustration of a “ring trap” 208 which also may serve as a magnetic field-generating component in the hybrid system shown in FIGS. 1 and 2. The ring trap is a single essentially circular current-carrying conductor deposited on a substrate (e.g., a gold wire or trace deposited on a sapphire or other substrate) with an insulating layer on top. As current is made to flow through the circular conductor, a magnetic field is generated from the ring trap; in one example, in a circular ring having a diameter of approximately 5 micrometers (μm), a 30 milliampere (mA) current flowing through the conductor can generate a magnetic field of approximately 10 Gauss, corresponding to a magnetic force of approximately 10 pico Newtons (pN) (which is more than sufficient to attract and trap a bead-bound bacterium, for example). Such ring traps may be disposed in a variety of configurations in relation to a microfluidic system, including one-dimensional or two-dimensional arrays of ring traps.

Yet other examples of devices that may serve as magnetic field-generating components in the hybrid system shown in FIGS. 1 and 2 include micro-scale magnets configured as coils, or “microcoils.” Some examples of microcoils including ferromagnetic cores and fabricated using micromachining techniques are given in U.S. Pat. Nos. 6,355,491 and 6,716,642, as well as International Application Publication No. WO00/54882, each of which publications is incorporated herein by reference. Yet another example of magnetic field-generating components according to one embodiment of the present invention includes a CMOS microcoil array and associated control circuitry. Further details of such a CMOS microcoil array are discussed below in Section II.

It should be appreciated that for virtually any hybrid system 100 according to the present disclosure based on a microelectronics portion configured to generate controllable spatially and/or temporally variable magnetic fields, a parallel implementation may be realized using configurations for generating controllable spatially and/or temporally variable electric fields, or a combination of variable magnetic fields and variable electric fields.

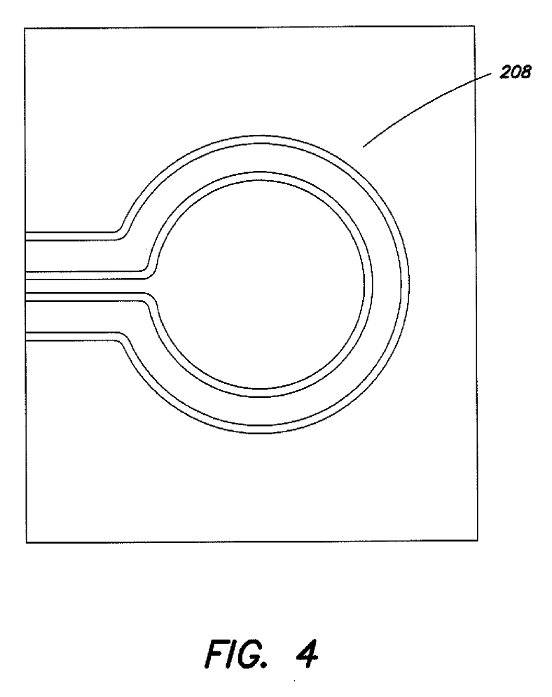

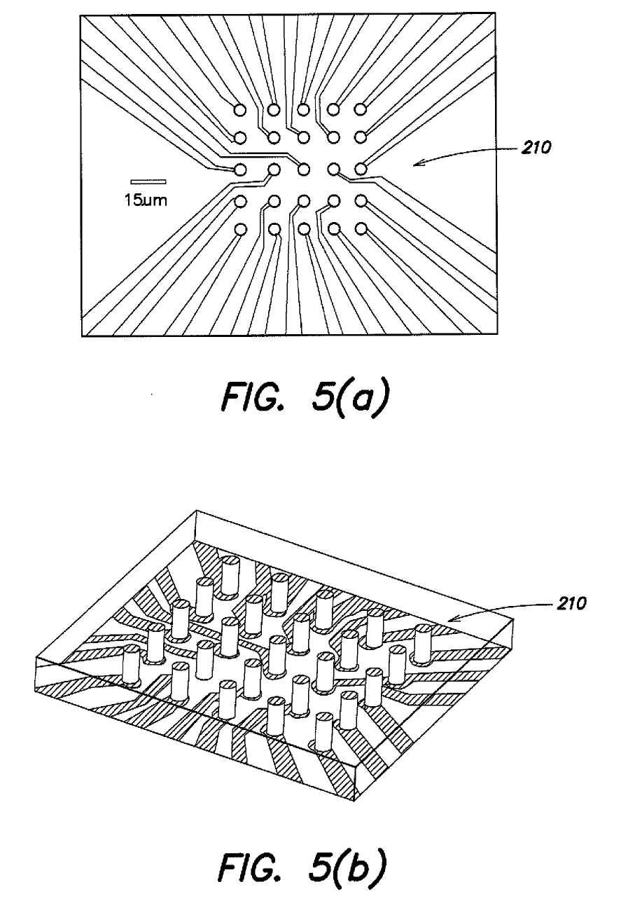

For example, in one embodiment, the field-generating components 200 of the hybrid system shown in FIGS. 1 and 2 may include an array of microelectrodes, or “microposts,” configured to generate controllable electric fields for manipulating objects of interest according to principles of dielectrophoresis. FIGS. 5(a) and (b) illustrate an example of such a micropost array 210; FIG. 5(a) illustrates a micrograph of a top view of such a fabricated micropost array including electrical attachment leads, where an exemplary scale for the depicted fabricated device of 15 micrometers (μm) is indicated in the legend in the left portion of the figure, and FIG. 5(b) illustrates a magnified perspective view of the exemplary array of FIG. 5(a), showing a two-dimensional arrangement of five columns and five rows of microposts.

As discussed above, dielectrophoresis occurs when an inhomogeneous electric field induces a dipole on a particle suspended in liquid. The subsequent force on the dipole pulls the particle to either a minimum or a maximum of the electric field. Almost any particle, without any special preparation, can be trapped or moved using dielectrophoresis when it is exposed to the proper local electric field. In this manner, according to one embodiment, one or more samples of interest suspended in liquid in the microfluidic system 300 may be manipulated via operation of the micropost array 210 to generate electric fields appropriate for this task.

More specifically, in one embodiment based on the micropost array 210 shown in FIGS. 5(a) and (b), each micropost in the array (or alternatively predetermined groups of microposts) may be connected to a controllable voltage source (discussed further below) so that all microposts (or groups of microposts) can have independent voltage potentials across them. By independently modulating the magnitude of the voltages across the respective microposts, various electric field patterns can be produced in proximity to (e.g., above) the micropost array 210 to facilitate manipulation of one or more samples of interest contained in the microfluidic system. To provide a ground for the respective micropost potentials, one exemplary geometry includes fabricating a ground plane adjacent to and above the micropost array (e.g., on a bottom surface of a microfluidic chamber), such that substantially all generated electric field lines point in the same direction. Alternatively, electric field maxima may be generated by applying different voltage potentials (e.g., plus and minus connections) to different (e.g., neighboring) microposts within the array, thereby obviating a ground plane.

In yet another embodiment, an array of microcoils may be configured to produce both controllable, spatially and/or temporally patterned, electric fields and/or magnetic fields. More specifically, in one implementation discussed further below in Section II, respective independently controllable voltages may be applied across the microcoils of a microcoil array, such that the individual microcoil structures behave essentially like the microposts of the micropost array 210 shown in FIGS. 5(a) and (b), namely, by generating electric fields that are capable of interacting with samples contained in the microfluidic system. According to one aspect of this embodiment, respective independently controllable currents also may be applied to the microcoils of the microcoil array, to additionally generate magnetic fields that are capable of interacting with magnetic samples contained in the microfluidic system. These and other types of electric field-based or electric/magnetic field-based implementations may be employed for a variety of applications relating to manipulation, sensing and imaging systems that integrate microelectronics and microfluidics.

As mentioned above and also shown in FIG. 1, the field control components 400 of the hybrid system 100 may include one or more current sources 420 to facilitate the generation of magnetic fields from magnetic field-generating components, according to some embodiments of the invention. Similarly, the field control components may also, or alternatively, include one or more voltage sources 440 to facilitate the generation of electric fields from electric field-generating components, according to other embodiments of the invention.

In general, whether the field control components 400 include one or more current sources 420, one or more voltage sources 440, or both, according to one embodiment the field control components also include various switching or multiplexing components 460 to facilitate the appropriate application of currents and/or voltages to individual field-generating components or groups of field-generating components. In various implementations discussed in greater detail below, the switching or multiplexing components 460 may be configured as a programmable digital switching network (e.g., under control of the one or more processors 600) such that the output(s) of one or more current and/or voltage sources are applied in a prescribed independently controllable manner to the field-generating components, so as to create the spatially and/or temporally patterned electric and/or magnetic fields that facilitate sample manipulation.

As also shown in FIG. 1, the field control components 400 additionally may include radio frequency (RF) and other detection components 480, coupled between the field-generating components 200 and the one or more processors 600, for facilitating one or more of detection, imaging and characterization of samples contained in the microfluidic system 300, according to various embodiments of the present disclosure. In different aspects, examples of such RF/detection components 480 may include, but are not limited to, oscillators, mixers and/or filters, which are operated (e.g., under control of the one or more processors 600 via the switching or multiplexing components 460) to both generate RF fields from the field-generating components and measure signals indicating some type of interaction between the generated RF fields and one or more samples of interest. Specific details of exemplary circuit implementations for the RF/detection components 480 are discussed further below in Section III.

In various aspects, the RF/detection components 480 provide for sample detection, imaging and characterization techniques that are purely based on electromagnetic fields, without requiring chemical elements that may possibly be harmful to samples of interest, or bulky optical microscopes. Nevertheless, it should be appreciated that, according to some techniques involving various concepts disclosed herein, sample detection and imaging may be assisted by chemically treating/targeting specific types of samples.

In general, as is well known based on Maxwell's Equations, an RF field is capable of interacting with virtually any particle (biological or otherwise) that conducts electricity at the RF signal frequency, or is polarizable electrically or magnetically. Accordingly, in various embodiments of the present disclosure, the interaction between RF electric and/or magnetic fields and samples of interest may be exploited not only to move samples but also to determine the position of the sample (e.g., to facilitate imaging). Moreover, spectral responses arising from the RF field/sample interaction may be used in some cases to identify or characterize different types or classes of samples.

For example, conducting samples have circulating currents induced by an RF field that in turn produce their own magnetic field, and interact strongly with an applied field. This is the basis of operation of conventional electric motors (e.g., a “squirrel cage” rotor with no electrical contacts). This interaction can be used to move samples and also detect their presence. In one mechanism discussed in greater detail below, magnetic polarization of a sample changes the inductance of a coil (e.g., a microcoil of an array) in proximity to the sample; accordingly, damping of oscillations of the magnetic polarization causes detectable losses in a circuit including the microcoil. In yet another example, electrical polarization of a sample gives rise to the forces responsible for dielectrophoresis (DEP). This polarization can be detected via a change in capacitance between the sample and the electrodes of an electric-field generating device (e.g., a micropost or microcoil with an applied voltage) with no dissipation, or by a change in damping due to the oscillating electric polarization in the sample. The foregoing examples provide various mechanisms by which the location of a sample can be detected, and thus imaged.

Based on such RF imaging techniques, various implementations of a hybrid system according to the present disclosure may incorporate feedback control mechanisms, whereby samples of interest may be manipulated based on acquired images of the samples. For example, in one embodiment, the hybrid system may be programmably configured (e.g., via the one or more processors 600) to first obtain an image of a distribution of samples contained in the microfluidic system. Thereafter, based on the imaged distribution, one or more particular samples may be manipulated based on a prescribed algorithm.

Various concepts disclosed herein relating to RF fields likewise may be employed for identification and characterization of samples of interest. For example, frequency dependent changes in either the electric or magnetic polarization of samples can be used to identify the type of sample, using knowledge of the behavior of various materials in electromagnetic fields from conventional solid state physics. These changes may be characterized over a broad range of frequencies. Accordingly, in one embodiment, by sweeping the RF frequency of signals applied to field-generating components (or using more sophisticated signal processing techniques), the frequency response (e.g., absorption spectrum) of the sample can be measured at a particular location, and the sample may be identified or characterized based on the measured response.

In yet other embodiments relating to the application of RF fields and sensing of field/sample interactions under the control of the RF/detection components 480, an RF field can be used to conduct local measurements of magnetic resonance in a uniform magnetic field applied to a sample. In particular, the spins or magnetic domains of a given sample oscillate with characteristic frequencies, which can be used to identify the type of spin or the sample itself. Magnetic resonance types include ferromagnetic resonance (FMR) (small YIG spheres can be used as magnetic beads, wherein a YIG sphere has a single magnetic domain that rotates freely at GHz frequencies because the bead is spherical). Additionally, Electron Spin Resonance (ESR) techniques may be employed to identify the g-factor of the spins involved to characterize their origin (i.e., the sample), as well as Nuclear Magnetic Resonance (NMR) to identify the g-factors of the nuclear spins. Thus, according to the principles discussed herein, a Magnetic Resonance Imaging (MRI) system may be implemented on a chip.

While not explicitly shown in FIGS. 1 and 2, according to various embodiments the field control components 400 also may include one or more analog to digital (A/D) and digital to analog (D/A) converters to facilitate the communication of various data and signals amongst other field control components, as well as to and from the IC chip 102. The field control components also may include digital signal processing components and signal amplification components to facilitate processing and transport of signals. Furthermore, the field control components may include a wireless transceiver and an antenna to facilitate wireless communication to and from the IC chip 102. In one exemplary wireless implementation, the ISM radio bands (free, non-commercial radio bands allowed for industrial, scientific and medical purposes) may be utilized for wireless communications between the IC chip 102 and a remote user or control interface (e.g., the one or more processors 600). Present wireless transceiver technology allows miniature, low-power transceivers to transmit and receive data at high data rates (e.g., several kilobits or megabits per second), which is sufficient for the reliable transfer of information to and from the IC chip 102.

Finally, FIGS. 1 and 2 also illustrate that the hybrid system 100 may include temperature regulation components 500 to facilitate biocompatibility of the hybrid system. For example, according to one embodiment, the temperature of the system may be regulated at or near a particular temperature to facilitate biocompatibility of the system with the samples under investigation. In one exemplary implementation, the temperature regulation components may include one or more “on-chip” temperature sensors 500A (e.g., in proximity to the microfluidic system 300, as shown in FIG. 2) and an “off-chip” temperature controller 500B (e.g., a thermoelectric or “TE” cooler attached to the package substrate 110, as shown in FIG. 2). In one aspect, the one or more on-chip temperature sensors 500A sense the temperature of the IC chip in proximity to the microfluidic system and the one or more processors 600 compare the measured temperature to a reference temperature (e.g., 37° C.). The one or more processors in turn send an appropriate feedback control signal to the off-chip temperature controller 500B, which heats up or cools down the whole substrate accordingly. Temperature regulation components 500 are discussed further below in Section IV.

Having provided a general overview of a hybrid system according to the present disclosure for manipulation, detection, imaging and characterization of samples using electromagnetic fields, more detailed descriptions of various concepts related to different portions of the hybrid system, as well as some exemplary applications for such a system, are set forth below.

II. Microcoil Array

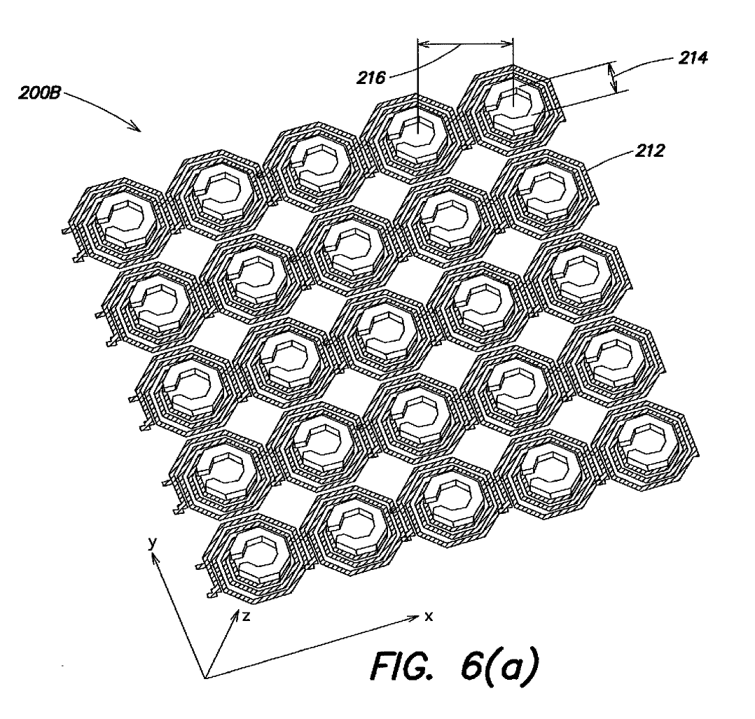

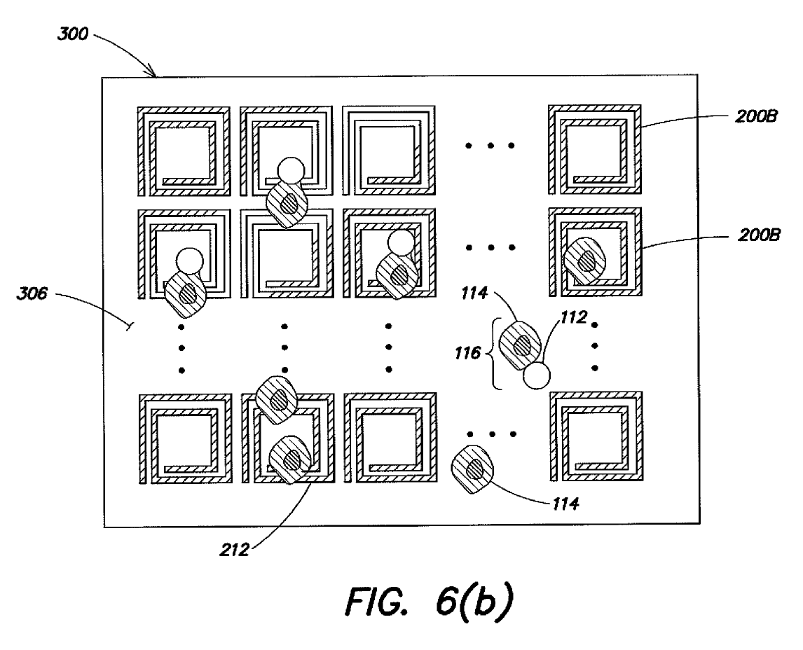

FIG. 6(a) is a conceptual perspective illustration of a microcoil array 200B that may be employed as field-generating components 200 in the hybrid system 100 shown in FIGS. 1 and 2, according to one embodiment of the present disclosure. In the example of FIG. 6(a), the array 200B includes five columns and five rows of essentially identical microcoils 212. Although FIG. 6(a) illustrates a five-by-five microcoil array, it should be appreciated that microcoil arrays according to various embodiments of the invention are not limited in this respect, and may have different numbers of microcoils and different geometric arrangements.

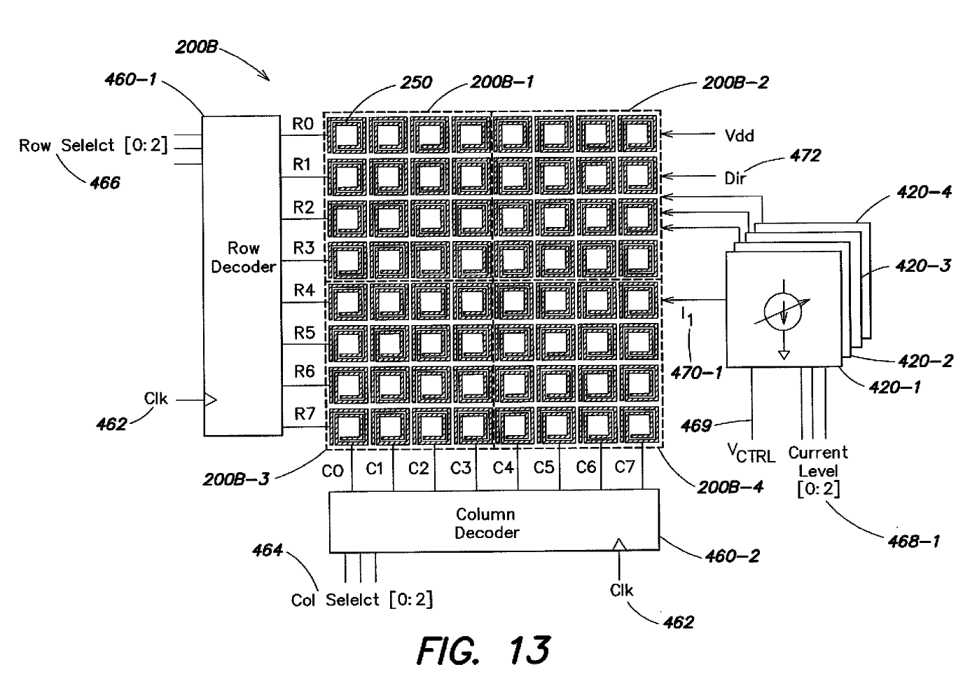

Like the microelectromagnet wire matrix 200A discussed above in connection with FIGS. 3(a)-(d), a microcoil array 200B similar to that shown in FIG. 6(a) may be configured and controlled to facilitate the manipulation of magnetic samples contained in the microfluidic system 300, including cells coupled to magnetic beads. FIG. 6(b) shows a conceptual illustration of a top (overhead) view of a portion of the array 200B shown in FIG. 6(a), looking down to the array through a portion of a microfluidic system 300 (e.g., a channel) that contains a liquid 306 in which are suspended exemplary samples 116 comprising a magnetic bead 112 attached to a cell 114 (i.e., a bead-bound cell). The liquid 306 also may contain one or more cells 114 that are not attached to a magnetic bead. In one embodiment, to manipulate the bead-bound cells 116 (or other types of magnetic samples), each microcoil 212 of the array 200B is independently connectable (via switching and multiplexing components, as discussed further below in connection with FIG. 13) to a source of controllable current. Thus, by independently controlling the magnitude of current flowing through each microcoil, various magnetic field patterns can be generated in proximity to the microcoil array 200B and employed to trap and otherwise manipulate magnetic samples.

As compared to the microelectromagnet wire matrix 200A, the microcoil array 200B generally is more efficient for at least some of the following exemplary reasons. First, the fields generated in the microcoil array are more highly localized than in the microelectromagnet wire matrix, thereby providing a relatively higher spatial resolution for trapping and transporting samples. Second, the microcoil array has a finer degree of magnetic field control than does the microelectromagnet wire matrix and can thus handle a larger number of samples simultaneously; specifically, a N×N microcoil array can effectively provide N² independent simultaneous local magnetic fields (based on N² independent currents), whereas an N×N wire matrix can provide only 2N independent simultaneous fields (based on 2N independent currents). Third, as discussed in greater detail below, a microcoil provides a better platform for RF detection owing to its well-defined inductance. Fourth, parasitic magnetic fields due to electrical leads generally are less significant in the microcoil array than in the microelectromagnet wire matrix.

One issue in the design of a two-dimensional microcoil array 200B according to one embodiment of the present disclosure relates to the magnetic force that can be generated in a plane immediately above and parallel to the array. This plane is indicated generally in both FIGS. 2 and 6(a) by an x axis and a y axis. In particular, the x-y component of magnetic force generated by the respective microcoils of an array must be large enough to move magnetic samples (e.g., biological cells attached to magnetic beads) that are suspended in a fluid within a reasonable range (e.g., a distance between centers of two neighboring microcoils, or “pitch” of the array, as indicated in FIG. 6(a) by the reference numeral 216) and within a reasonable time (e.g., 1 sec or less), overcoming surface frictions and fluid viscosity. Another design issue relates to magnetic potential energy; to maintain a sufficiently strong trap of a magnetic sample while at the same time suppressing thermal jitters (i.e., Brownian motion) and diffusion due to a thermal energy of the sample, the magnetic potential energy generated by the respective microcoils must be substantially larger than the thermal energy of the sample (i.e., 3/2 kT, where k is the Boltzmann constant and T is the sample temperature). Yet another design issue relates to magnetic force in a direction perpendicular to the plane of the array, along a z axis as indicated in both FIGS. 2 and 6(a) (the z axis illustrated in FIG. 6(a) is in perspective view, and actually points in a direction out of the plane of the figure). Based on the technology and methodology used to fabricate the microcoil array, there may be one or more material layers above the array (e.g., insulating, protecting and or biocompatible material layers, etc.) that extend an appreciable distance above the array along a direction parallel to the z axis, over which the generated magnetic field may fall off rapidly.

With the foregoing issues in mind, one embodiment of the present disclosure is directed to a microcoil array fabricated on a semiconductor (e.g., Si) substrate using conventional CMOS process technology. In one aspect of this embodiment, various field control components, including control electronics for the microcoil array, are integrated together with the microcoil array and fabricated as a CMOS IC chip, so as to provide for the generation of spatially and/or temporally variable magnetic fields for sample manipulation, as well as RF fields to facilitate sample detection, imaging and characterization. In particular, in exemplary implementations, the microcoils themselves are formed using standard CMOS protocols and hence do not require any micromachining techniques (e.g., as in micro-electro-mechanical structures, or MEMS implementations).

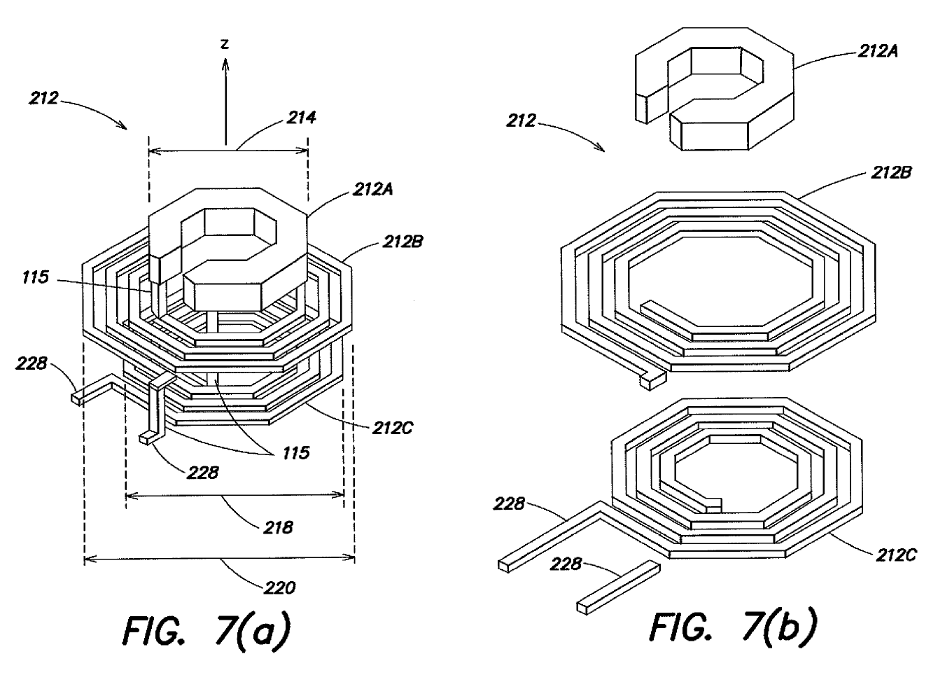

More specifically, to address the design issues noted above, according to one embodiment multiple metal layers available in a CMOS fabrication process are employed in the microcoil configuration to allow generation of adequate magnetic field strengths sufficient to effectively trap and transport samples. FIGS. 7(a) and 7(b) show perspective and exploded views, respectively, of an exemplary three-layer microcoil 212 according to this embodiment, and FIG. 8 conceptually illustrates a vertical layer structure of a portion of a CMOS IC chip 102 showing the three-layer microcoil in relation to other features and layers of the overall chip structure. A z axis corresponding to that shown in FIGS. 2 and 6(a) is also indicated in FIGS. 7 and 8. It should be appreciated that the exemplary three-layer microcoil structure shown in FIGS. 7 and 8 is provided primarily for purposes of illustration, and that microcoils according to other embodiments may include different numbers of layers (e.g., two or more) and/or have different overall shapes or geometries. In general, according to various embodiments, microcoils similar to those shown in FIGS. 7 and 8 may include at least two axially concentric spatially separated portions (e.g., layers) of conductor turns.

As illustrated in FIGS. 7 and 8, the exemplary microcoil 212 includes three coiled conductor portions or layers, namely, an upper portion 212A, a middle portion 212B and a lower portion 212C. To facilitate precision spatial control of individual magnetic samples contained in the microfluidic system above an array of microcoils 212, each microcoil is designed to generate a single magnetic field peak above the microcoil to interact with samples. For example, as illustrated conceptually in FIG. 8, a magnetic sample 116 (e.g., a bead-bound cell, as also shown in FIG. 6(b)) suspended in a liquid contained in the microfluidic system 300 is attracted to a magnetic field peak generated above the microcoil 212 when an appropriate current flows through the microcoil. In FIG. 8, a distance between the upper portion 212A of the microcoil (as fabricated in the overall layered structure of the IC chip 102), and a bottom or floor of the microfluidic system 300 is indicated with the reference numeral 120.

As discussed generally above, the principle of operation of the microcoil array 200B for magnetic sample manipulation is to create and move one or more magnetic field peaks by modulating currents in the respective microcoils 212 of the array. For example, consider first “turning on” (i.e., passing current through) only one microcoil 212 of the array (e.g., the microcoil shown in FIG. 8); as shown in FIG. 8, the magnetic sample 116 is attracted to a magnetic field peak generated by the microcoil 212 and is thus trapped at the center of the microcoil above the surface of the IC chip 102. Near the generated magnetic field peak, the “trapping force” is given by

F=Vχ/μₒ∇B², (1)

where V is the volume of the magnetic bead 112, χ is the effective magnetic susceptibility of the bead, μₒ is the magnetic permeability of a vacuum, and B is the generated magnetic field magnitude. If this microcoil is then “turned off” while an adjacent microcoil of the array is turned on, the magnetic field peak is moved to the center of the adjacent microcoil, thereby transporting the magnetic bead to the new peak location.

The magnetic field B required to generate a particular trapping force F is proportional to the current flowing through the microcoil and the inductance of the microcoil; the inductance of the microcoil is in turn proportional to the number of turns of the microcoil and the size (diameter) of the microcoil. Accordingly, a microcoil design that provides a relatively high inductance generally is desirable to provide for a magnetic field of sufficient strength to trap samples. At the same time, to maintain a fine spatial resolution amongst the microcoils of the array and facilitate sample transport between adjacent microcoils, it is generally desirable to have a relatively small inter-coil spacing or pitch 216 and relatively small diameter 214 of the upper portion 212A of a microcoil, as indicated in FIG. 6(a).

Accordingly, in various aspects of this embodiment, the overall number of turns of the microcoil and the diameter of each coiled portion is appropriately selected to provide an appropriate array pitch, as well as an appropriate microcoil inductance to generate sufficient magnetic fields, to facilitate sample trapping and transport between microcoils. To this end, the multiple layer microcoil structure shown in FIGS. 7 and 8 uses vertical space in the layered CMOS chip design to obtain a greater number of turns per microcoil to provide for higher inductance. At the same time, distributing the turns amongst different levels or portions of the microcoil allows for different diameters in different levels/portions of the microcoil, which facilitates small inter-coil spacing or pitch between adjacent coils while at the same time providing an effective microcoil inductance.

More specifically, in the exemplary microcoil shown in FIGS. 7 and 8, the upper portion 212A, which is closest to the surface of the IC chip and hence closest to samples in the microfluidic chamber, may be fabricated as a single turn of a metal conductor having a relatively small diameter 214, the size of which may be determined by the average size of a sample that is to be trapped. In one exemplary implementation, the diameter 214 of the upper portion 212A may be on the order of approximately 10-11 μm; it should be appreciated that generally this diameter is greater than approximately 5 μm, due to present limitations of CMOS fabrication techniques. The diameter 214 of the upper portion 212A also may be selected, based at least in part, on the overall desired size of the microcoil array 200B and the desired pitch 216. In general, to ensure appropriate resolution between adjacent magnetic fields, the spacing between upper portions of adjacent microcoils should be no less than approximately the diameter 214 of each of the upper portions; this results in a pitch 216 approximately twice that of the diameter 214 (again, it should be appreciated that increased resolution of the array is fundamentally limited by the resolution of the fabrication process). Based on this general relationship, in various implementations, the diameter 214 and the pitch 216 can range from a couple of micrometers to a few tens of micrometers, depending on types of samples under consideration and applications involved.

As also illustrated in FIGS. 7(a) and (b), the middle portion 212B and the lower portion 212C of the microcoil may have larger diameters than the upper portion. In one aspect, the larger diameters of the middle and lower portions is possible because the spacing between adjacent middle and lower portions of adjacent microcoils in the array may be smaller than the spacing between adjacent upper portions without compromising the resolution of the generated magnetic fields (i.e., the resolution of the generated magnetic fields is largely determined by the top metal layer). Thus, the middle and lower portions generally may include a greater number of turns and/or a larger diameter than the upper portion, thereby providing for a relatively higher microcoil inductance. Additionally, as shown in FIGS. 7(a) and (b), the lower portion 212C may include tabs 228 to facilitate connection of the microcoil 212 to a current (or voltage) source, as discussed further below. In one exemplary implementation, each of the middle and lower portions may include three conductor turns, wherein a diameter 220 of the middle portion 212B may be on the order of approximately 20-25 μm, and a diameter 218 of the lower portion 212C may be on the order of approximately 15-20 μm (the relatively smaller diameter of the lower portion permits the inclusion of the tabs 228). In other implementations, different numbers of conductor turns and/or different dimensions may be used for respective coil portions, and may be determined empirically or based on numeric simulations of desired magnetic fields for different applications.

With reference now to the IC vertical layer structure illustrated in FIG. 8, the IC chip 102 includes a semiconductor substrate layer 104, above which is sequentially fabricated the three layers/portions 212C, 212B and 212A of the microcoil 212. Each of the layers/portions 212C, 212B and 212A may be formed by deposition and patterning of a conducting metal, such as copper, gold, or aluminum, for example. The multiple metal layers are separated from each other and other layers of the IC chip by an insulating material 112 comprising, for example, silicon oxide (SiO₂) or another suitable dielectric material. The three layers/portions 212C, 212B and 212A are electrically coupled together to create a continuous multi-layer conducting loop by vias 114 (e.g., made of tungsten) that extend through the insulating material 112 (the vias 114 also are indicated in the perspective view of FIG. 7(a)).

In one embodiment, the CMOS processing techniques employed to fabricate the vertical layer structure shown in FIG. 8 (e.g., Taiwan Semiconductor Manufacturing Company CMOS 0.18 μm technology) yield a thickness 222 for the upper metal layer/portion 212A of approximately 1 to 3 μm. The upper metal layer also may be patterned such that the line width in the x-y plane (i.e., perpendicular to the plane of FIG. 8) of the metal conductor is also approximately 1 to 3 μm, such that the metal conductor cross section for the upper portion 212A is from approximately 1×1 μm² to approximately 3×3 μm² (it should be appreciated that, based on the TSMC 0.18 μm design rule, the line width of the upper metal layer—metal 6—may be as small as 0.44 μm).

With respect to the middle and lower layers/portions 212B and 212C, the CMOS processing techniques may yield a thickness 224 for both the lower and middle layers/portions of approximately 0.5 to 1 μm. These layers may be patterned such that the line width in the x-y plane is also approximately 0.5 to 1 μm, yielding a metal conductor cross section for the lower and middle portions of approximately 0.5×0.5 μm² to approximately 1×1 μm². A distance 226 between the metal layers may be on the order of approximately 1 μm (it should be appreciated that, based on the TSMC 0.18 μm design rule, the distance between the metal layers may be as small as 0.46 μm).

Based on the foregoing general dimensions, a microcoil inductance on the order of approximately 1 nano Henry (1 nH) or higher may be achieved. By generally decreasing various dimensions relating to the metal conductors, the number of coil turns may be increased, resulting in inductances as high as 60 to 100 nano Henries (60-100 nH). It should be appreciated, however, that as the width of metal conductors becomes smaller, the parasitic resistance of the coil generally increases and the maximum allowable current through the coil generally decreases, which ultimately limits the strength of the magnetic field that may be generated; hence, there may be practical trade-offs between coil size and field strength.

More generally, it should be appreciated that the vertical layer structure shown in FIG. 8 is not limited to the above-indicated dimensions, or to three metal layers; based on present CMOS fabrication technology, up to approximately seven metal layers would be possible. Thus, again, the three layer microcoil structure is presented as merely one example of a number of possible microcoil configurations according to the present disclosure.

As shown in the vertical layer structure of FIG. 8, above the insulating material 112 a passivation layer 116 is deposited, which may comprise, for example, silicon nitride or polyimide. Finally, to ensure biocompatibility, a polydimethylsiloxane (PDMS) layer 118 is deposited above the passivation layer 116 and serves as the interface with the microfluidic system 300. In various implementations, a distance 120 between the upper metal layer/portion 212A of the microcoil and the interface between the PDMS layer 118 and the microfluidic system 300 may be on the order of approximately 3-4 μm.

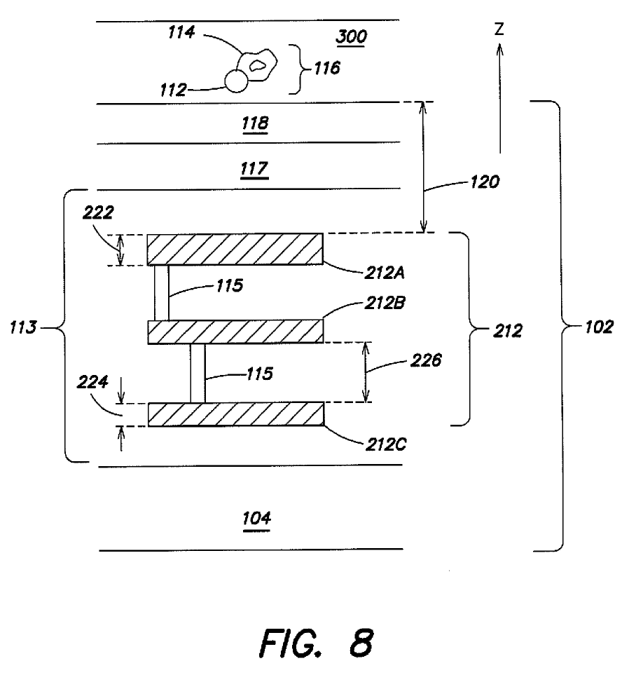

Based on the general structure of a CMOS microcoil as outlined above, significant local magnetic fields may be generated above each microcoil of the array 200B to manipulate samples. To provide an illustrative range of values for magnetic field strength and sample trapping force, a two-layer microcoil structure having an overall diameter of approximately 20 μm and 4 coil turns per layer is considered. The exemplary microcoil includes an aluminum conductor having an average conductor cross-section of 1×1 μm², wherein the line width is 1 μm, the gap between adjacent conductor turns of a given layer is 1 μm, and the distance between the two layers is 1 μm. The maximum current density for an aluminum conductor is approximately 200 mA/μm²; hence, the exemplary microcoil under consideration is capable of supporting approximately 200 mA of maximum current flowing through it. FIG. 9 illustrates the magnetic field profile in an x-y plane located at approximately 1 μm above such a microcoil, near the floor of the microfluidic system in which a sample would be located. As observed in FIG. 9, based on a maximum current of 200 mA flowing through the microcoil, a significant magnetic field peak on the order of approximately 300 Gauss is generated.

If a sample of interest includes a cell coupled to a conventionally available magnetic bead (e.g., Dynabead) having a diameter of approximately 4-5 μm and a magnetic susceptibility x of approximately 0.25, the force F exerted on the sample by the peak magnetic field of approximately 300 Gauss shown in FIG. 9, according to Eq. (1) above, is on the order of approximately 1 nano Newton (nN). This force is more than sufficient for effective manipulation of such bead-bound samples. Stated differently, the maximum fluidic velocity that a trapped sample can withstand based on such a force F is on the order of 1 centimeter/second. Additionally, the magnetic potential energy generated by the microcoil with 200 mA of current is on the order of 3×10⁶ times larger than the thermal energy for such a bead-bound sample at a biologically compatible temperature of 37 degrees C. (T=310 K), demonstrating a strong trap capability of the microcoil.

While the foregoing example is based on an exemplary maximum current through the microcoil, it should be appreciated that significantly lower currents (e.g., on the order of approximately 20 mA) nonetheless provide sufficient peak magnetic fields and resulting forces (e.g., on the order of approximately 10 pico Newtons) for the effective manipulation of a variety of magnetic samples. Generally, the magnitude of magnetic force generated by the microcoil increases with current through the microcoil. In some instances, as current is increased toward a maximum current, a high current density in a microcoil over a prolonged period may result in electromigration, a phenomenon in which a large current in a narrow conductor gradually results in metal void failures. Electromigration generally is more pronounced at higher temperatures, though. Hence, in the hybrid systems described herein (in which operating temperatures typically would be below 50 degrees C., and in some cases regulated for biocompatibility at 37 degrees C.), current densities that generate magnetic forces sufficient for effective sample manipulation generally would not cause significant electromigration.

Moreover, while the foregoing example demonstrates that microcoils similar to those shown in FIGS. 7 and 8 can provide appreciable magnetic forces for sample manipulation, some particular applications may require magnetic forces even greater than those illustrated above. Accordingly, in another embodiment, Permalloy, a conventionally known nickel alloy containing about 20% Iron and 80% Nickel, which can be easily magnetized and demagnetized depending on the current surrounding it to enhance magnetic force, may be employed in the microcoil design. In particular, in one exemplary fabrication process, Permalloy may be appropriately deposited (e.g., electroplated) in the multi-layer microcoil structure (i.e., with submicron scale resolution) using photolithography or e-beam lithography techniques.

According to yet another embodiment, “vertical” microcoils may be fabricated and used in manipulation and imaging of magnetized samples, similarly to the multi-layer microcoils described above. Presently available CMOS technologies support primarily planar metal layers, and hence the microcoils discussed above are essentially “planar” in that they are disposed along a plane parallel to the x-y axes indicated in the various figures, and generate magnetic fields perpendicular to the surface of the IC chip 102 (i.e., essentially along the z axis). However, in another embodiment, by employing micromachining and/or other three-dimensional assembly processes as post-fabrication steps, it is possible to tilt the planar microcoil away from the substrate surface (after removal of oxide), yielding a vertical microcoil. Such a vertical microcoil produces a magnetic field parallel to the surface of the IC chip 102 (i.e., essentially in a plane parallel to the x-y axes). By employing both vertical and planar microcoils in one implementation according to the present disclosure, three-dimensional sample manipulation is possible, including rotation in addition to linear transport. In the context of RF detection and imaging discussed in greater detail below, the vertical microcoil may allow large-signal RF perturbations for imaging, while the planar microcoil provides a DC field to manipulate the samples, thereby enhancing the capability of a hybrid system incorporating both vertical and planar microcoils.

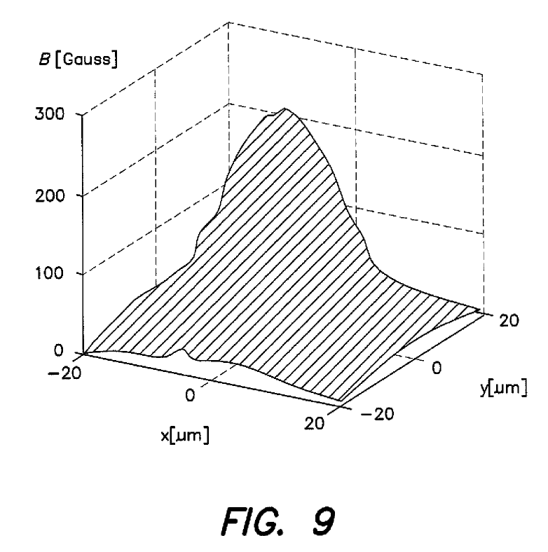

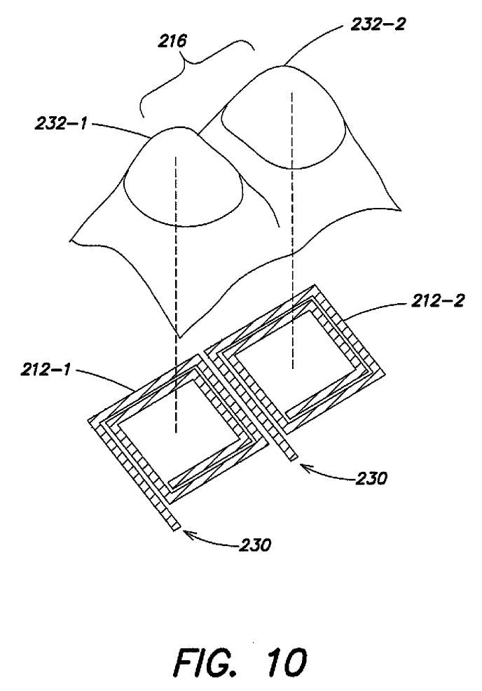

Having discussed various aspects of the structure and fabrication of an exemplary microcoil according to the present disclosure based on conventional semiconductor fabrication processes, the interaction between neighboring microcoils in an array with respect to the generation of magnetic fields for sample manipulation is now considered in greater detail. As discussed above, the principle of operation of the microcoil array 200B shown in FIGS. 6(a) and (b) is to create and move one or more magnetic field peaks by modulating currents in the respective microcoils 212 of the array so as to move and/or trap magnetic samples. The magnitude of the magnetic field generated by a given microcoil of the array is based on the magnitude of the current flowing through the microcoil, and each microcoil in the array is capable of generating a local magnetic field peak above the microcoil. In this sense, the array 200B may be thought of generally in terms of “magnetic pixels,” wherein an N×N array of microcoils is capable of producing at least N×N magnetic peaks, or “pixels,” each capable of attracting and trapping a sample. FIG. 10 conceptually illustrates two neighboring microcoils 212-1 and 212-2 of the array 200B, in which an essentially equal current 230 flows through the microcoils to generate two essentially equal magnetic field peaks 232-1 and 232-2 above the coils. In FIG. 10, the distance between the two magnetic field peaks generally corresponds to the pitch 216 of the array 200B, as indicated in FIGS. 6(a) and 10.

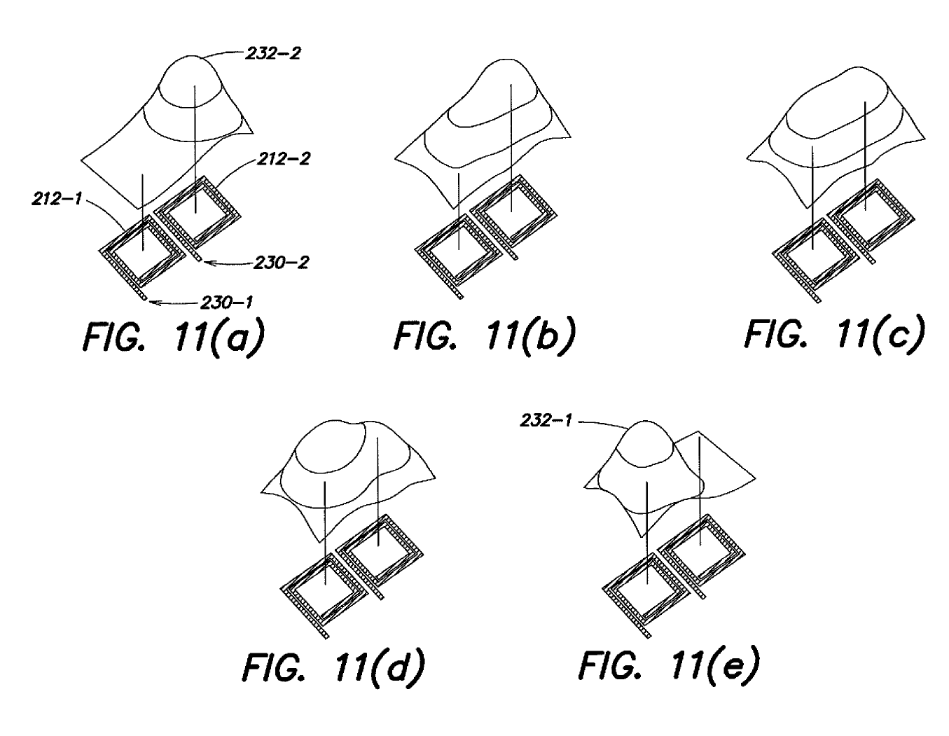

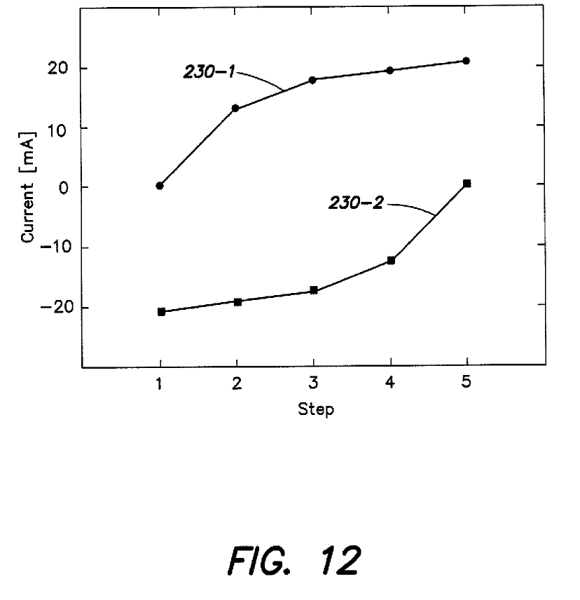

In one embodiment, not only may the magnitude of the current flowing through each microcoil be modulated to facilitate sample manipulation, but also the direction of the current flowing through a given coil may be altered, so as to facilitate a smoother transition of a sample from pixel to pixel, or effectively increase the spatial resolution for sample manipulation (i.e., effectively decrease the pitch 216 of the array). FIGS. 11(a)-(e) show five exemplary scenarios for the neighboring microcoils 212-1 and 212-2 of FIG. 10, with varying current magnitudes and directions in the respective coils and the resulting magnetic fields generated. FIG. 12 is a graph illustrating the current magnitude and direction in each of the coils for each of the five exemplary scenarios illustrated in FIGS. 11(a)-(e). On the horizontal axis of FIG. 12, the steps 1-5 correspond respectively to the five scenarios illustrated in FIGS. 11(a)-(e). The upper plot shown on the graph of FIG. 12 indicates the current 230-1 flowing through the “left” microcoil 212-1 in each scenario, and the lower plot indicates the current 230-2 flowing through the “right” microcoil 212-2 in each scenario.

In particular, in FIG. 11(a), as indicated in step 1 of the graph of FIG. 12, the left microcoil 212-1 has no current flowing through it, while the right microcoil 212-2 has −20 mA of current flowing through it. As a result, a magnetic field peak 232-2 is generated above the right microcoil 212-2. In one exemplary implementation based on the microcoil structure discussed above in connection with FIGS. 7-9, the magnitude of the magnetic field peak 232-2 thus generated may be on the order of approximately 30 Gauss. In FIG. 11(b), as indicated in step 2 of FIG. 12, the current 230-1 in the left microcoil is increased to approximately 12-13 mA, while the current 230-2 in the right microcoil is decreased to approximately −19 mA. As shown in FIG. 11(b), the magnetic field starts to broaden somewhat above the two microcoils, as there is now some field contribution from both the left and right microcoils.

In FIG. 11(c), as indicated in step 3 of FIG. 12, the left and right microcoils have equal magnitude currents flowing through them (approximately 17-18 mA), but in opposite directions; as a result, a broad magnetic field peak is generated, roughly centered over the midpoint between the centers of the respective coils. In FIG. 11(d), the current 230-1 is further increased in the left microcoil 212-1 and the current 230-2 is further decreased in the right microcoil 212-2, and in FIG. 11(e) the current 230-1 ultimately is increased to 20 mA while the current 230-2 ultimately is reduced to zero; as a result, a single magnetic field peak 232-1 is maintained over the left microcoil 212-1. It should be appreciated that the respective fields generated in FIGS. 11(a) and 11(e) have the same magnitude, but opposite field directions. Accordingly, by gradually varying currents of different directions through the coils, a magnetic field peak may be continuously moved between two adjacent coils, thus effectively enhancing the resolution of the array to facilitate precise positioning as well as smooth translation of samples across the array 200B.

As discussed above in connection with FIGS. 1 and 2, in one embodiment various field control components 400 for controlling and distributing current (and/or voltage) to the microcoils of the array 200B may be integrated together with the array in an IC chip 102. In one exemplary implementation, these field control components include one or more current sources (and/or voltage sources), as well as various switching or multiplexing components to facilitate digital (and computer programmable) control of the fields generated by the array 200B.

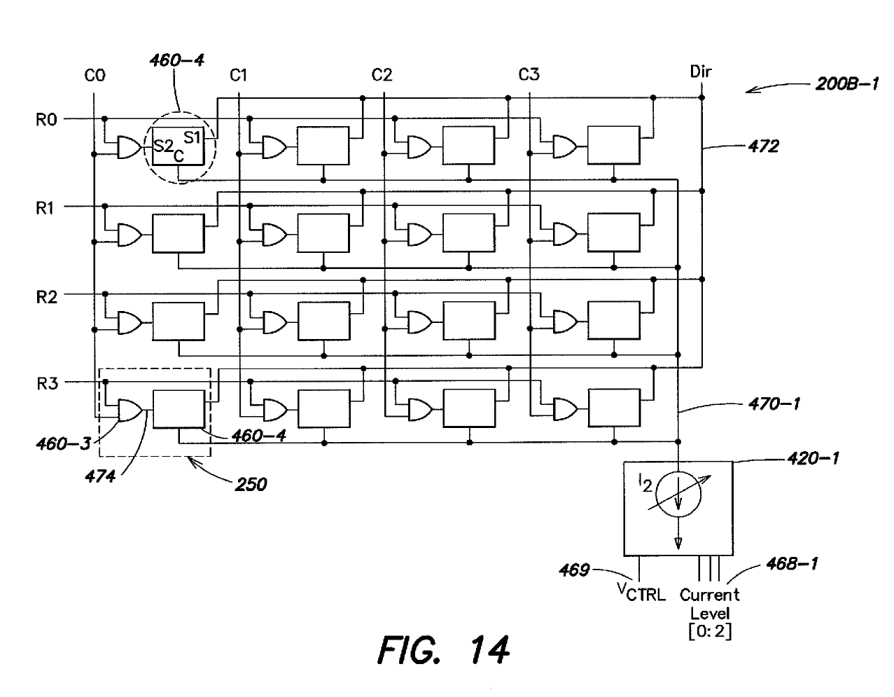

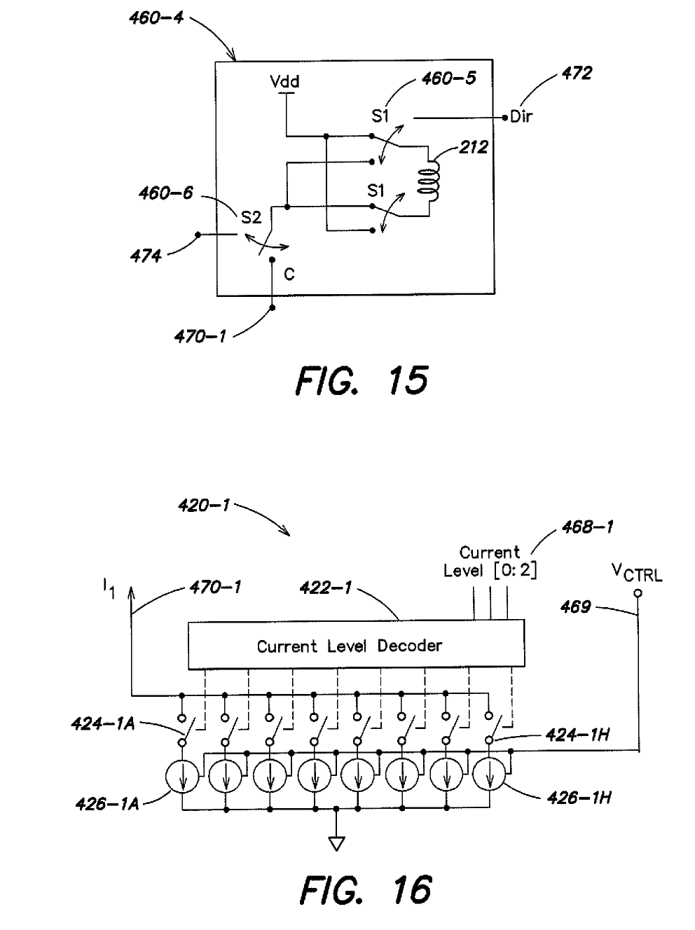

FIG. 13 is a diagram showing the microcoil array 200B and various field control components associated with the array 200B, according to one embodiment of the present disclosure. In the example of FIG. 13, the array 200B includes eight rows and eight columns of “microcoil cells” 250, wherein each microcoil cell includes a microcoil 212, as well as switches and logic circuits, as discussed further below in connection with FIGS. 14 and 15. For purposes of distributing current (and/or voltage) to the microcoil cells 250, the array 200B of this embodiment is divided into four quadrants 200B-1, 200B-2, 200B-3 and 200B-4, each quadrant having sixteen microcoil cells 250 (i.e., four rows and four columns per quadrant). It should be appreciated, however, that microcoil arrays and associated control components according to the present disclosure are not limited in this respect, and that the particular configuration shown in FIG. 13 is provided primarily for purposes of illustration.

As shown in FIG. 13, the various field control components associated with the array 200B in this embodiment include a row decoder 460-1 that provides row enable signals R0-R7 to respective rows of the array 200B, and a column decoder 460-2 that provides column enable signals C0-C7 to respective columns of the array. The row decoder receives as inputs three digital row select signals 466 (Row Select [0:2]) coded in binary to generate a desired one of the row enable signals R0-R7 at any given time. Similarly, the column decoder receives as inputs three digital column select signals 464 (Column Select [0:2]) coded in binary to generate a desired one of the column enable signals C0-C7 at any given time. Both the row decoder 460-1 and the column decoder 460-2 receive a common clock signal 462 (Clk) that serves to synchronize the generation of a given row enable signal and a given column enable signal so as to select a particular one of the microcoil cells 250 at a given time. In one exemplary implementation, the clock signal 462, row select signals 466 and column select signals 464 are provided by one or more processors 600, as discussed above in connection with FIGS. 1 and 2, such that these signals may be generated pursuant to programmable and/or user-selected computer control.

FIG. 13 also conceptually illustrates four variable current sources 420-1, 420-2, 420-3 and 420-4 that provide a controllable variable current to the microcoil cells 250 of the array 200B. An exemplary one of the four current sources, namely variable current source 420-1, is shown as configured to receive three digital current level signals 468-1 (Current Level [0:2]) and a control voltage 469 (V_{CTRL}), and provide as an output to the array a controllably variable current 470-1 (I₁). As discussed further below in connection with FIG. 16, in one embodiment the variable current source 420-1 is configured to provide one of eight different currents based on the digital binary coded current level signals 468-1 and a voltage of the control voltage V_{CTRL}. In the configuration of FIG. 13, while not explicitly indicated in the figure, each of the other current sources 420-2, 420-3, and 420-4 also receive as inputs three binary coded digital current level signals and the control voltage V_{CTRL}, and provides a corresponding variable current output having eight different possible current levels. In one aspect of this embodiment, the digital current level signals for each of the variable current sources may be provided by one or more processors 600, as discussed above in connection with FIGS. 1 and 2, such that these signals may be generated pursuant to programmable and/or user-selected computer control.

Finally, FIG. 13 also illustrates that the array 200B of this embodiment receives a DC power supply voltage Vdd common to all of the microcoil cells 250 of the array, as well as a “direction” signal 472 (Dir), also common to all of the microcoil cells 250, that determines the direction (polarity) of current flowing through the microcoils of each microcoil cell 250. This direction signal 472 is discussed in greater detail below in connection with FIGS. 14 and 15.

In one aspect of the embodiment of FIG. 13, the variable current sources are configured with respect to the microcoil cells such that each current source provides current to all of the microcoils in one quadrant of the array. For example, in one implementation, the current source 420-1 provides current to the microcoils of the first quadrant 200B-1, the current source 420-2 provides current to the second quadrant 200B-2, the current source 420-3 provides current to the third quadrant 200B-3, and the current source 420-4 provides current to the fourth quadrant 200B-4. In this configuration, each quadrant of the array 200B operates in a substantially similar fashion; accordingly, one quadrant of the array is now discussed in greater detail.

FIG. 14 is a diagram illustrating various interconnections of components in the first quadrant 200B-1 of the array 200B shown in FIG. 13, according to one embodiment of the present disclosure. The row enable signals R0-R3, provided by the row decoder 460-1 in FIG. 13, are shown on the left side of FIG. 14, and the column enable signals C0-C3, provided by the column decoder 460-2 in FIG. 13, are shown on the top of FIG. 14. The first quadrant 200B-1 includes sixteen identical microcoil cells 250 arranged in four rows and four columns and coupled to the row enable signals and column enable signals. Each of the microcoil cells 250 also is coupled to the direction signal 472 (which is shared by all quadrants of the array), as well as the variable current source 420-1, which provides the controllably variable current 470-1 (I₁) to all microcoil cells of the quadrant 200B-1. As also illustrated in FIG. 14, each microcoil cell 250 includes a logic AND gate 460-3 that provides a coil enable signal 474 when both the row enable signal and column enable signal corresponding to the cell are present. The coil enable signal 474 is applied to a microcoil switching unit 460-4, which includes a microcoil 212 and various switches for controlling current through the microcoil upon application of the coil enable signal 474.

FIG. 15 illustrates the contents of the microcoil switching units 460-4 shown in FIG. 14. Each microcoil switching unit includes a microcoil 212 (e.g., similar to those discussed above in connection with FIGS. 7-12) connected to a current direction (polarity) switch 460-5 (S1) and a coil enable switch 460-6 (S2). The power supply voltage Vdd is applied to the polarity switch S1, and a connection to the variable current source (indicated as C in FIG. 15) is provided to the coil enable switch S2 to allow the current 470-1 to flow through the coil when the switch S2 is closed. The polarity switch S1 is controlled by the direction signal 472, and the coil enable switch S2 is controlled by the coil enable signal 474; specifically, the coil enable signal 474 causes the switch S2 to close to allow the current 470-1 to pass through the microcoil 212 when both the row enable signal and column enable signal corresponding to the microcoil cell that includes the microcoil are present. In one aspect of this embodiment, the direction signal 472 may be provided by one or more processors 600, as discussed above in connection with FIGS. 1 and 2, such that this signal may be generated pursuant to programmable and/or user-selected computer control.

FIG. 16 illustrates details of the variable current source 420-1 that provides the controllably variable current 470-1 to the first quadrant 200B-1 of the array. Again, in FIG. 13, the other current sources 420-2, 420-3 and 420-4 may be implemented identically to the current source 420-1. According to one embodiment, the current source 420-1 includes a current level decoder 422-1 that receives the digital binary coded current level signals 468-1 and provides eight enable outputs to selectively close one of eight switches 424-1A through 424-1H (in one exemplary implementation, the current level decoder 422-1 may employ a “thermometer code”). One side of each switch is connected to a “base” current source, such that there are eight different base current sources 426-1A through 426-1H. The other side of each switch 424-1A through 424-1H is connected in common to provide the controllably variable current 470-1 (I₁), having one of eight different possible current levels at any given time (i.e., the current I₁ is some multiple of the current provided by a given base current source).

In one aspect of this embodiment, each of the base current sources 426-1A through 426-1H may be implemented in a conventional manner using MOS transistors, wherein the current provided by each base source is determined by the control voltage 469 (V_{CTRL}). For example, in one exemplary implementation, the control voltage V_{CTRL} may be applied to all of the base current sources such that a particular control voltage provides a corresponding current from each base source (e.g., a control voltage of 0.7 to 3.3 Volts generates a corresponding current in each base source of from 0 to 1.3 milliamperes). It should be appreciated that, in different implementations, the control signal V_{CTRL} may be varied to provide for variable base currents or alternatively may be held constant (e.g., connected to Vdd).

Furthermore, it should be appreciated that although the variable current source 420-1 shown in FIG. 16 is configured to provide eight different current levels, the present disclosure is not limited in this respect; namely, a general configuration similar to that shown in FIG. 16 may be implemented to provide a different number of current levels based on multiple base current sources, which may be selectable via a decoder similar to that shown in FIG. 16 by digital signals having an appropriate number of bits based on the number of current levels to be provided. In yet other embodiments, a pulse width modulation technique may be employed using a single base current source to provide the variable current 470-1. In such embodiments, a fixed current provided by a single source is pulse width modulated to have different duty cycles, wherein a relatively lower duty cycle represents a lower average current and a relatively higher duty cycle represents a higher average current. In one aspect, the number of possible duty cycles to provide different average current levels may be determined in a manner similar to that employed in the configuration of FIG. 16, wherein digital binary coded signals applied to a decoder provide for a number of different possible duty cycles, and hence different currents.

In the embodiments discussed above in connection with FIGS. 13-16 various field control components, including variable current sources, switching and multiplexing components, logic gates, and the like, are employed as a “digital switching network” that effectively controls and distributes current in the microcoil array 200B. In one aspect of these embodiments, such a digital switching network makes control of the array 200B more practicable, especially in implementations in which the number (N²) of microcoil cells 250 may be significantly large; more specifically, current may be time-shared in a multiplexed manner amongst multiple microcoils, and a relatively small number of digital signal inputs may be employed to control the entire microcoil array. With reference again to FIG. 13, again the signals required in this embodiment to provide for array control and facilitate sample manipulation include a clock signal 462, three column select signals 464, three row select signals 462, twelve current level signals (i.e., three signals for each of four variable current sources, as indicated by the signals 468-1 for one of the current sources), a control voltage 469 (V_{CTRL}) for the current sources, and a direction (polarity) signal 472. As discussed above, any one or all of the foregoing signals may be provided by one or more processors 600, as shown in FIGS. 1 and 2, such that these signals may be generated pursuant to programmable and/or user-selected computer control.

In FIGS. 13-16, the various control signals generally are provided such that one microcoil of the array is enabled at any given time to generate a magnetic field having different possible field strengths based on the variable current passing through the microcoil. Accordingly, in one aspect of this embodiment, to generate multiple magnetic fields to effectively trap or move multiple samples “simultaneously,” different microcoils of the array are sequentially enabled (i.e., current to the microcoils is multiplexed) on a time scale that is significantly faster than a “reaction time” of the samples to the presence or absence of a magnetic field. In this manner, sequentially generated magnetic fields may appear to be simultaneously generated to the samples in question. Multiple microcoils of the array may be sequentially enabled (e.g., under computer control) on an appropriate time scale according to any one of a variety of “scanning protocols;” for example, in one exemplary implementation, a conventional “raster scanning” protocol may be employed to sequentially enable each microcoil of the array on a row by row basis, starting from the top left corner of the array shown in FIG. 13 and proceeding to the right along the first row, and then to the second row, etc.

To provide some exemplary illustrations of appropriate scanning time scales for sample manipulation, a commercially available magnetic bead (e.g., Dynabead) having a diameter of approximately 4-5 μm is considered in a liquid water environment as a representative magnetic sample. In general, samples suspended in a liquid experience a viscous drag as they move through the liquid; this viscous drag generally affects the speed with which a sample reacts to an external magnetic field (and hence the “response time” of the sample). For a magnetic sample suspended in a liquid, the response time τ_{cutoff} is given as

τ_{cutoff}≈O(μμₒ/χB²), (2)

where μ is the dynamic viscosity of the liquid. Accordingly, if the sample is exposed to a pulsed magnetic field having a frequency that is significantly higher than the sample's “cutoff frequency” (i.e., the reciprocal of the sample's response time), the pulsed magnetic field appears to exert an essentially continuous average magnetic force on the sample. In this manner, one current source may be multiplexed amongst multiple microcoils of an array (i.e., sequentially applied in time) at an appropriate rate to generate seemingly continuous magnetic forces from the perspective of the samples in question. The magnetic force resulting from a magnetic field was discussed generally in connection with Eq. (1) above. For a Dynabead in water having a diameter of approximately 5 μm under a magnetic field on the order of 30 Gauss, the response time τ_{cutoff} is on the order of 10⁻² seconds. Using a pulsed magnetic field having a frequency greater than the reciprocal of the sample's response time (e.g., >approximately 100 Hz), the resulting force is equal to the product of the duty cycle and the force given by Eq. (1).

Once a sample is attracted to a local magnetic field, a sufficient magnetic potential energy must be maintained to trap the sample in the field. In particular, a sample suspended in a liquid moves chaotically due to random collisions of the sample with the surrounding liquid molecules, a phenomenon known as Brownian motion. Such Brownian motion can lead to diffusion of the sample; with random velocity, the sample can move in a random path (e.g., in a tangled zig-zag manner) away from its location at any given time due to Brownian motion. As discussed above, the kinetic energy associated with this motion is proportional to temperature (i.e., 3/2kT). Accordingly, to maintain a trap, the average magnetic potential energy of the generated field must be sufficiently greater than the sample's thermal energy.

In view of the foregoing, once a sample is initially trapped based on a pulsed magnetic field, the sample may remain trapped in the pulsed magnetic field as long as the magnetic field is not off for a period of time that allows significant diffusion of the sample away from the “trapping area” above a given microcoil. An upper limit for the field off-time τ_{off} is given approximately by τ_{off}<d²/D, where d is the diameter of the microcoil and D is the diffusion constant of the sample (from the definition of D, for a given time t, a particle travels an average distance d=(Dt)^{1/2}). The diffusion constant D of a sample (in meters² per second) is given generally by

D=kT/3πηα (3)

where η is the viscosity of the liquid (in kg/m's) and α is the diameter of the sample. In the exemplary scenario under consideration, the viscosity η of water is approximately 10⁻³ kg/m·s and the diameter of the Dynabead sample is 5 μm; accordingly, assuming a temperature T of approximately 300 K (i.e., room temperature), the diffusion constant D for the Dynabead sample in water is approximately 8.5×10⁻¹⁴ m²/s. If a microcoil diameter of 20 μm is assumed, τ_{off} should be less than approximately 5000 seconds. From a practical standpoint, the foregoing example illustrates that multiplexing current to the microcoils at a rate of 10,000 Hz or higher (i.e., τ_{off}<10⁻⁴ seconds) permits practically no appreciable diffusion of the sample due to Brownian motion; with an off-time τ_{off}<10⁻⁴ seconds, the 5 μm Dynabead diffuses approximately only 3 nanometers.

In general, it should be appreciated that the configuration of current sources and microcoils illustrated in FIGS. 13-16 and the multiplexing technique described above are provided as an exemplary implementation, and that other configurations according to the present disclosure are possible. For example, in alternative configurations, the array 200B may be subdivided into greater or fewer subdivisions (e.g., four microcoil cells per subdivision instead of sixteen), wherein a variable current having a predetermined number of different current levels for each subdivision is provided by one current source dedicated to the subdivision. Alternatively, in another implementation, only one such current source may provide current to all the microcoil cells of the array 200B in a sequential time-shared (e.g., multiplexed) manner. In yet another configuration, each microcoil cell may be equipped with its own variable current source, such that there is no need to multiplex one current source amongst multiple microcoils. In general, any implementation that makes use of a current-sharing scheme by using one current source to provide current to multiple microcoils reduces DC power dissipation from the system.

It should also be appreciated that while the exemplary concepts discussed above in connection with FIGS. 13-16 focus on microcoils driven by current sources, alternative implementations of field-generating arrays for sample manipulation based on the general switching and multiplexing architecture outlined in FIGS. 13-16 may be based on electric-field generation and dielectrophoresis principles using microcoils or microposts driven by voltage sources.

For example, first consider the microcoil array 200B of FIG. 13 and associated control components, with a substitution of one or more variable (or fixed) voltage sources for the variable current sources. In one such exemplary implementation, respective microcoil cells 250 of the array are selected/enabled in the same manner described above in connection with FIGS. 13-15. However, rather than passing a variable current though a selected/enabled microcoil, a variable voltage (having a selectable polarity based on the direction signal 472) may be connected to the selected/enabled microcoil to generate a corresponding electric field from the microcoil (e.g., a variable voltage source may replace the variable current source 420-1 shown in FIG. 14, and upon selecting/enabling a given microcoil and the microcoil polarity via the signal 472, a variable voltage would essentially be placed in series with the power supply voltage Vdd across the microcoil). One or more variable voltage sources of such an alternative implementation may be realized by any number of conventional configurations (e.g., a digital-to-analog converter) suitable for various integrated circuit fabrication processes.

In another example based on electric field generation, the microcoil array 200B of FIG. 13 may be substituted by an appropriately-sized micropost array similar to that discussed above in connection with FIGS. 5(a) and (b), and again the variable current sources would be substituted by one or more variable (or fixed) voltage sources. In yet another example, the microcoil array 200B of FIG. 13 may be employed with both variable current sources and variable voltage sources to provide a subsystem capable of sample manipulation based on both electric and magnetic fields. These and other types of electric field-based or electric/magnetic field-based implementations may be employed for a variety of applications relating to manipulation, sensing and imaging systems that integrate microelectronics and microfluidics.

III. Sample Detection, Imaging and Characterization

As discussed above in Section I, with reference again to FIG. 1, the field control components 400 of a semiconductor-based/microfluidic hybrid system additionally may include radio frequency (RF) and other detection components 480, coupled between the field-generating components 200 and the one or more processors 600, for facilitating one or more of detection, imaging and characterization of samples contained in the microfluidic system 300, according to various embodiments of the present disclosure. In different aspects, the RF/detection components 480 are configured to facilitate both the generation of electromagnetic fields from the field-generating components based on relatively high frequency (e.g., RF, microwave) electric signals (voltages or currents), as well as the measurement of signals indicating some type of interaction between the generated RF fields and one or more samples of interest.

In general, as is well known based on Maxwell's Equations, an RF field is capable of interacting with virtually any particle (biological or otherwise) that conducts electricity at the RF signal frequency, or is polarizable electrically or magnetically. Accordingly, in various embodiments of the present disclosure, the interaction between RF electric and/or magnetic fields and samples of interest may be exploited not only to move samples as discussed above in Section II, but also to determine the position of the sample (e.g., to facilitate imaging).

For example, conducting samples have circulating currents induced by an RF field that in turn produce their own magnetic field, and interact strongly with an applied field. This interaction can be used to move samples and also detect their presence. In one mechanism discussed in greater detail below, magnetic polarization of a sample changes the inductance of a coil (e.g., a microcoil of an array) in proximity to the sample and, in turn, this inductance change can be detected using high frequency signals. In yet another example, electrical polarization of a sample gives rise to the forces responsible for dielectrophoresis (DEP). This polarization can be detected via a change in capacitance between the sample and the electrodes of an electric-field generating device (e.g., a micropost or microcoil with an applied voltage) with no dissipation, or by a change in damping due to the oscillating electric polarization in the sample.

The foregoing examples provide various mechanisms by which the location of a sample can be detected. Based on the capability to detect the position of a sample relative to a given field generating component, in one embodiment each of the field generating components 200 is analogous to an imaging pixel (e.g., consider a two-dimensional CCD array) that provides valuable information toward constructing a comprehensive image of a sample distribution suspended in a microfluidic system. In another embodiment, images of sample distributions in turn may be used as feedback to manipulate one or more samples according to a prescribed algorithm.

In one embodiment based on magnetic bead-bound samples, the effect of the bead's magnetism on the inductance of a microcoil is exploited to facilitate sample detection. For example, the inductance L of a given microcoil is proportional to an effective magnetic permeability μ_{eff}. Without any magnetic particles in the vicinity of the microcoil, μ_{eff} is equal to the magnetic permeability of a vacuum μₒ, but in the presence of a magnetic bead (e.g., a paramagnetic particle, or PMP) having some magnetic permeability μ_{bead}, the effective permeability associated with the microcoil is μ_{eff}=(1−α) μₒ+αμ_{bead} (where a<<1) thereby altering the inductance of the microcoil by some amount ΔL. Accordingly, by monitoring the inductance L of a microcoil via high frequency signals applied to the microcoil, such changes ΔL in the microcoil's inductance may be detected, thereby indicating the presence of a bead-bound sample in the vicinity of the microcoil.

Depending on the size and hence inductance of the microcoil and the magnetic permeability of the bead, changes in inductance ΔL may range from approximately 0.1% of L to 1% of L (e.g., a Dynabead having a diameter of approximately 4.5 to 5 micrometers and a magnetic permeability μ_{bead} of approximately 1.25 μₒ can cause a change in inductance ΔL on the order of 0.1% of L). Also, the frequency response of the bead's magnetic permeability also should be taken into consideration; in particular, for the Dynabead example, μ_{bead} has a real value for frequencies below approximately 100 MHz. Hence, in one exemplary implementation, RF signals below or approximately 100 MHz are employed in the detection scheme.

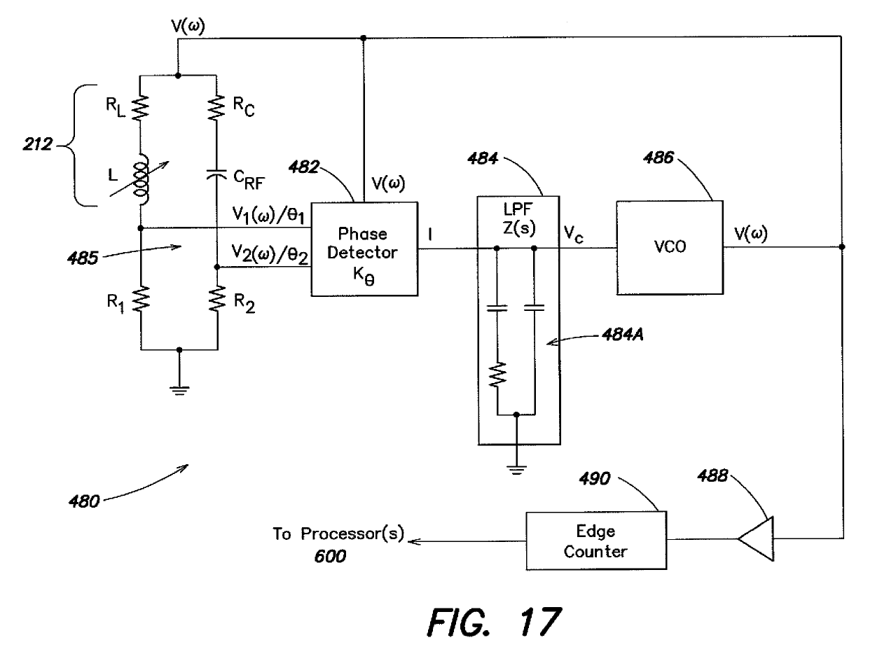

FIG. 17 is a diagram illustrating an arrangement of RF/detection components 480 that forms a “frequency locked loop,” according to one embodiment of the present disclosure, for facilitating sample detection. In the embodiment of FIG. 17, an exemplary microcoil 212 is shown in terms of its variable inductance L (which changes in the presence of a magnetic sample) and its associated coil resistance R_{L}. In one aspect of this embodiment, the variable inductance L and coil resistance R_{L} form part of a bridge circuit 485, which also includes a known predetermined capacitance C_{RF} (having a parasitic resistance R_{C}) and two know resistances R₁ and R₂.

For ease of illustration and to facilitate the following discussion, the remaining components in FIG. 17 are shown directly connected to the microcoil 212; it should be appreciated, however, that in other embodiments, the remaining RF/detection components 480 shown in FIG. 17 may be shared amongst multiple microcoils of a microcoil array in a multiplexed fashion, along with other circuitry providing DC current to the microcoils for purposes of sample manipulation as discussed above. For example, another signal similar to the direction signal 472 may be used, together with the row and column select signals and additional switches as appropriate (e.g., in a manner similar to that discussed above in connection with FIGS. 13-15), to facilitate operation of microcoils for both manipulation and detection purposes using multiplexed RF and DC signals.

As mentioned above, in the embodiment of FIG. 17 a “frequency locked loop” is formed by the bridge circuit 485, a phase detector 482, a low pass filter 484, and a voltage controlled oscillator (VCO) 486. Generally speaking, the phase detector, low pass filter and voltage controlled oscillator are similar to well-known components conventionally found in phase locked loop configurations. However, the combination of a uniquely arranged bridge circuit including the microcoil 212, together with the other indicated components, results in a locking circuit based on frequency rather than phase, wherein the locking frequency varies in direct relationship to changes in the inductance L due to the presence of a sample. Accordingly, by monitoring changes in the locking frequency of the circuit shown in FIG. 17, the presence of a sample in proximity to the microcoil may be detected.

To explain the operation of the circuit shown in FIG. 17, we first consider an exemplary implementation in which the output V(ω) of the VCO 486 is a sinusoidally varying voltage having an angular frequency ω that is a function of a control voltage V_{c} input to the VCO. Using the phasor notation Ae^{jθ} to express sinusoidal voltages (where A represents amplitude and θ represents phase), and expressing all phases relative to the output of the VCO 486, the voltages V₁(ω) and V₂ (ω) taken from the bridge circuit 485 may be expressed as V₁e^{jθ1} and V₂ₑ^{jθ2}, where

$$\begin{matrix}θ 1 = - arctan \frac{ω L}{{R}_{1} + {R}_{L}} \\ and & ( 4 ) \\ θ 2 = arctan \frac{1}{ω {C}_{RF} ( {R}_{2} + {R}_{C} )} . & ( 5 )\end{matrix}$$

As discussed in further detail below, the frequency locked loop is configured such that the control voltage V_{c} stabilizes at some DC value when θ1=θ2. Accordingly, from the above equations (4) and (5), a “lock frequency” ω_{lock} for the frequency locked loop may be expressed as

$${ω}_{lock} = \sqrt{( \frac{1}{{LC}_{RF}} ) ( \frac{{R}_{1} + {R}_{L}}{{R}_{2} + {R}_{C}} )} . \qquad ( 6 )$$

From the foregoing, it may be appreciated that the lock frequency ω_{lock} is essentially a function of changes in the microcoil inductance L, as C_{RF}, R_{L}, R_{C}, R₁, and R₂, are known fixed values. In one exemplary implementation, a nominal microcoil inductance L on the order of 1 nH is considered, with a nominal coil resistance R_{L} of approximately 50Ω. To ensure that ω_{lock} is below or approximately 100 MHz, C_{RF} is chosen at 1 pF, with a typical R_{C} on the order of approximately 1 kΩ, R₁ is chosen at approximately 50Ω and R₂ is chosen at approximately 10 kΩ.

To measure changes in inductance ΔL due to the presence of a magnetic sample in proximity to a microcoil, an instantaneous lock frequency ω_{lock} is measured and compared to a nominal lock frequency representing the absence of a magnetic sample. In exemplary implementations in which ω_{lock} is nominally approximately 100 MHz in the absence of a magnetic sample, changes in the lock frequency Δω_{lock} due to the presence of a magnetic sample may be on the order of approximately 50 to 100 kHz. In FIG. 17, the buffer amplifier 488 is employed to transform V(ω) to a square wave, for which an edge counter 490 may be employed (e.g., a series of flip-flops) to determine changes in the frequency ω. In particular, in one implementation, the edge counter 490 may be configured to count square wave edges during a given time period and provide a digital output representing such a count to the one or more processors 600 shown in FIGS. 1 and 2, from which changes in the frequency to representing the presence of a sample may be determined.

In the circuit arrangement illustrated in FIG. 17, the function of the phase detector 482 is to output a current I=K_{θ} (θ2-θ1), where K_{θ} is some constant. This current I is applied to the low pass filter 484 which, in the Laplace domain, has a transfer function

$$Z ( s ) = \frac{s + z}{s ( s + p )} , \qquad ( 7 )$$

where z is a zero and p is a pole of the transfer function. From the foregoing, it can be seen that the transfer function Z(s) includes a pole at s=0 in the denominator, due to the presence of the capacitor 484A. An expression for the control voltage V_{C} in the Laplace domain then may be given as

V_{C}(s)=IZ(s)=K_{θ}(θ2−θ1)Z(s). (8)

From the foregoing, it may be observed that in steady state (s=0), Z(s) tends to infinity; hence, to ensure a stable control voltage V_{C}, the quantity (θ2−θ1) must tend to zero in steady state. Accordingly, the capacitor 484A in the low pass filter 484 essentially ensures that the frequency locked loop stabilizes when θ2=θ1, thereby providing the expression for ω_{lock} given above.

FIG. 18 illustrates further details of the phase detector 482 of the frequency locked loop shown in FIG. 17, according to one embodiment of the present disclosure. As shown in FIG. 18, the phase detector includes two phase comparators 4821 and 4822, each designed to output an “up” signal or a “down” signal based on a phase relationship between the two signals applied to the comparator. For example, taking the signal V(ω) as a reference signal applied to each comparator, a given comparator outputs a pulse width modulated “up” signal if the other input signal to the comparator leads the reference signal; alternatively, the comparator outputs a pulse width modulated “down” signal if the other input signal lags the reference signal. A duty cycle of the respective up and down signals is proportional to the amount of the corresponding lead or lag.

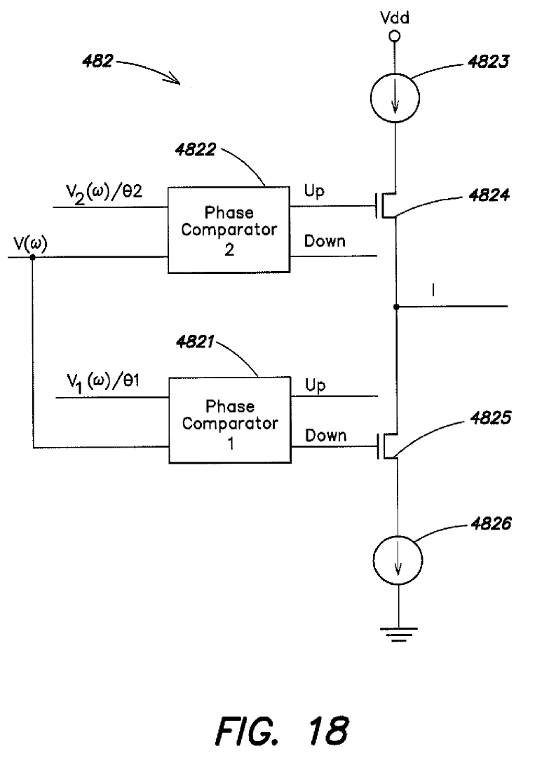

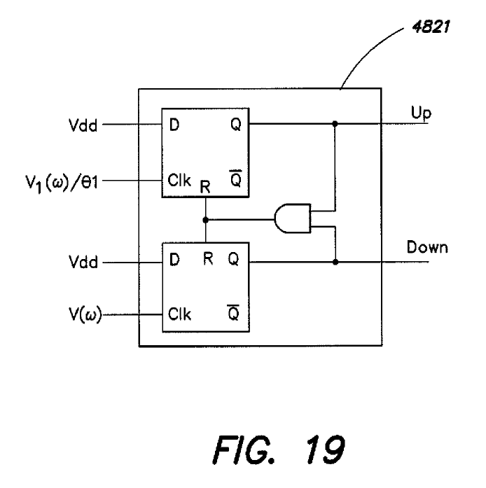

Based on the configuration of the bridge circuit 485 shown in FIG. 17, it may be observed that, in the phase detector 482 shown in FIG. 18, the signal V₂(ω) always leads the reference signal V(ω) by the phase θ2 and the signal V₁(ω) always lags the reference signal V(ω) by the phase θ1. Accordingly, in the implementation shown in FIG. 18, the “up” signal of the phase comparator 4821 is never active and accordingly remains unconnected in the circuit; likewise, the “down” signal of the phase comparator 4822 is never active and accordingly remains unconnected in the circuit. FIG. 19 illustrates further details of the phase comparator 4821 of the phase detector 482 shown in FIG. 18 (the phase comparator 4822 is configured similarly to the comparator 4821). As shown in FIG. 19, the phase comparator 4821 includes two D-flip flops and a logic AND gate coupled between the respective Q outputs and reset inputs (R) of the flip-flops.

In one aspect of the embodiment of FIG. 18, the up signal from the comparator 4822 periodically activates transistor 4824, based on the amount of phase lead between V₂(ω) and V(ω), to allow the current Ito be sourced by a current source 4823; in this manner, with reference again to FIG. 17, the capacitors of the low pass filter 484 are “pumped” with current based on the amount of phase lead between V₂(ω) and V(ω). Similarly, the down signal from the comparator 4821 periodically activates transistor 4825, based on the amount of phase lag between V₁(ω) and V(ω), to draw current from the capacitors of the low pass filter (to ground) based on the amount of phase lag between V₁(ω) and V(ω). At steady state, the combined activity of the pumping and drawing of current results in a net current I equal to zero, corresponding to the condition θ2=θ1.

FIG. 20 illustrates an alternative arrangement of RF/detection components 480A for facilitating sample detection according to another embodiment of the present disclosure. The arrangement of FIG. 20 represents a homodyne detection system in which two voltage controlled oscillators VCO (I) and VCO(Q) of a frequency synthesizer 4802 generate sin ωt (in-phase, or I) and cos ωt (quadrature-phase, or Q) signals, respectively. The in-phase (sin) RF signal excites the microcoil 212, which then modifies the excitation signal's phase and amplitude. The response of the microcoil (output of the low-noise amplifier, or LNA) is then multiplied by the original in-phase signal in Mixer 1, and multiplied by the quadrature-phase signal in Mixer 2. The DC output of Mixer 1 (OUT 1) is proportional to the parasitic resistance R_{L} of the microcoil, while the DC output of Mixer 2 (OUT 2) is proportional to the inductance L of the microcoil. Hence, by monitoring OUT 2, a change in microcoil inductance due to a magnetized sample (e.g., a bead-bound cell) can be determined, thereby indicating the presence of a sample.

In one aspect of the embodiment illustrated in FIG. 20, low-noise design may be significantly advantageous to realize high-accuracy RF sample sensing, given that the microcoil inductance change ΔL due to a single magnetic bead, as discussed above, may be as low as 0.1˜1% in some exemplary cases. Accordingly, in one exemplary implementation, the frequency synthesizer 4802 may be implemented using significantly low-noise high frequency oscillators based on coplanar striplines, similar to those discussed in U.S. Non-provisional application Ser. No. 10/894,674, filed Jul. 19, 2004, entitled “Methods and Apparatus Based on Coplanar Striplines,” and U.S. Non-provisional application Ser. No. 10/894,717, filed Jul. 19, 2004, entitled “Methods and Apparatus Based on Coplanar Striplines,” incorporated by reference herein.

Having discussed the detection of a magnetic sample, various concepts disclosed herein relating to RF fields likewise may be employed for identification and characterization of samples of interest. For example, frequency dependent changes in either the electric or magnetic polarization of samples can be used to identify the type of sample, using knowledge of the behavior of various materials in electromagnetic fields from conventional solid state physics. These changes may be characterized over a broad range of frequencies. Accordingly, in one embodiment, by sweeping the RF frequency of signals applied to field-generating components (or using more sophisticated signal processing techniques), the frequency response (e.g., absorption spectrum) of the sample can be measured at a particular location, and the sample may be identified or characterized based on the measured response.

In yet other embodiments relating to the application of RF fields and sensing of field/sample interactions under the control of the RF/detection components 480, an RF field can be used to conduct local measurements of magnetic resonance in a uniform magnetic field applied to a sample. In particular, the spins or magnetic domains of a given sample oscillate with characteristic frequencies, which can be used to identify the type of spin or the sample itself. Magnetic resonance types include ferromagnetic resonance (FMR) (small YIG spheres may be used as magnetic beads, as each sphere has a single magnetic domain that rotates freely at GHz frequencies because the bead is spherical). Additionally, Electron Spin Resonance (ESR) techniques may be employed to identify the g-factor of the spins involved to characterize their origin (i.e., the sample), as well as Nuclear Magnetic Resonance (NMR) to identify the g-factors of the nuclear spins. Thus, according to the principles discussed herein, a Magnetic Resonance Imaging (MRI) system may be implemented on a chip.

IV. Temperature Regulation

As mentioned above in connection with FIGS. 1 and 2, according to one embodiment the hybrid system 100 may include temperature regulation components 500. In exemplary implementations involving a significant number of field generating components 200 and accompanying field control components 400, the power consumption of the system may be appreciable and operation of these components may increase the temperature in and around the system. In view of the foregoing, the temperature of the system may be regulated at or near a particular temperature to facilitate biocompatibility of the system with the cells/samples under investigation, and also to reduce the risk of electromigration failure as mentioned earlier.

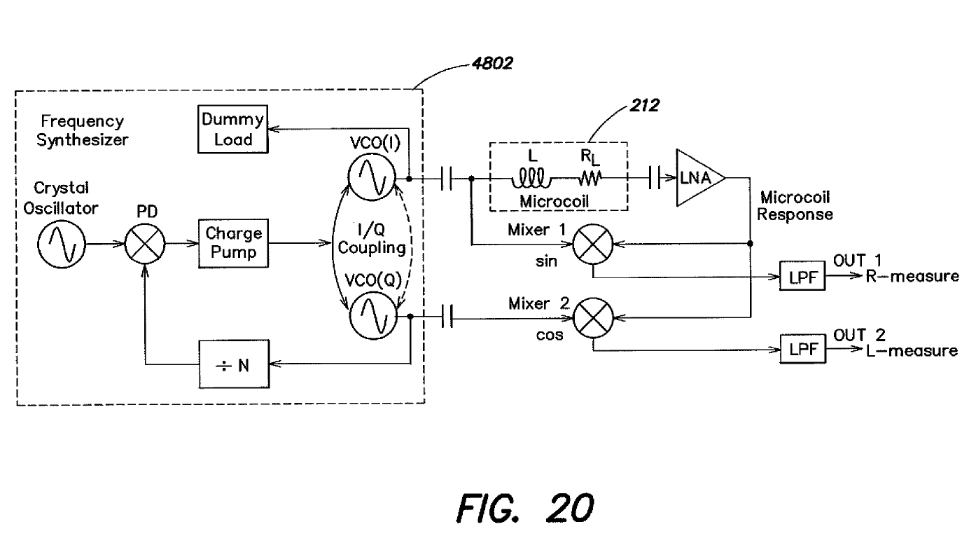

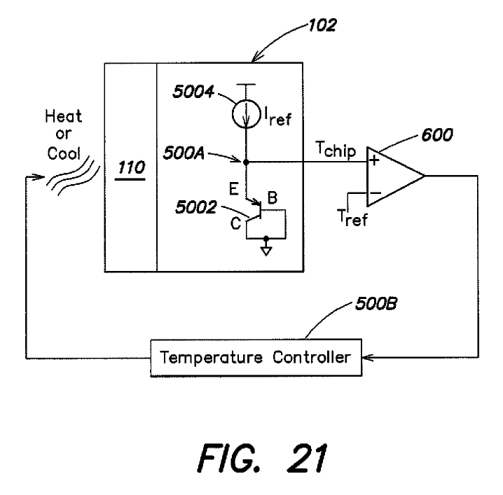

More specifically, according to one embodiment as illustrated in FIG. 21, the temperature regulation components 500 may include one or more on-chip temperature sensors 500A and an off-chip temperature controller 500B. With reference for the moment again to FIG. 2, in various implementations multiple on-chip temperature sensors 500A may be disposed at a variety of locations in and around the IC chip 102; in FIG. 21, one exemplary temperature sensor 500A is illustrated generally in the environment of the IC chip 102, which is in turn coupled to the package substrate 110. In one aspect of this embodiment, the one or more on-chip sensors 500A provide one or more temperature signals T_{chip} to the processor 600, which is shown for purposes of illustration in FIG. 21 as a comparator that compares the signal T_{chip} to a reference temperature signal T_{ref} (in one exemplary implementation, T_{ref} may represent a temperature of 37 degrees C.).

In various implementations, the processor 600 may be configured to receive multiple temperature signals from respective different on-chip sensors, and process the multiple signals according to one or more predetermined algorithms (e.g., averaging, weighted averaging based on chip location, etc.) to provide some aggregate sensed temperature value, which then may be compared to the reference temperature. Based on a comparison of one or more sensed temperatures and the reference temperature, a control signal is provided to the off-chip temperature controller 500B, which heats up or cools down the package substrate 110 accordingly (e.g., a thermoelectric or “TE” cooler may be used as the off-chip controller 500B in one exemplary implementation). In another aspect of this embodiment, the thermal conductivity across all the layers and within each layer of the IC chip 102 is such that the whole system can be assumed to be at the same temperature. Thus, the regulation loop is sufficient to keep the temperature of the overall system at a constant value.

In the embodiment of FIG. 21, the exemplary on-chip temperature sensor 500A includes a parasitic pnp bipolar transistor 5002 and a reference current source 5004 (available in any standard CMOS process). If the transistor's emitter current is kept constant at a reference current I_{ref}, the emitter-base voltage of the transistor is given as

$${V}_{EB} = - log ( \frac{{I}_{ref}}{{I}_{S}} ) \cdot \frac{kT}{q} , \qquad ( 9 )$$

where the logarithm is base e, I_{S} is the leakage current of the transistor, k is Boltzmann's constant, q is the electron charge, and T is the absolute temperature. The above equation indicates that the emitter voltage can be used as a direct measure of the chip temperature (T_{chip}). In one embodiment, the processor 600 compares this emitter voltage to a calibrated voltage representing the reference temperature (e.g., T_{ref}=37° C.) using a 1-bit comparator. If T_{chp}>T_{ref}, a control signal provided by the processor operates the temperature controller 500B to cool the chip, and vice versa.

In various implementations, the accuracy and long-term stability of the temperature regulator may be affected by mismatching of integrated components, drift of component parameters, l/f (flicker) noise, and mechanical stress. To improve the accuracy of the temperature regulator loop, in some embodiments various conventional analog integrated circuit design techniques may be utilized, such as auto-zeroing, adaptive calibration and dynamics element matching, and signal-chopping and averaging.

V. Microfluidic System

With reference again to FIGS. 1 and 2, once an IC chip 102 including one or more of field generating components 200, field control components 400 and temperature regulation components 500 is fabricated, a microfluidic system 300 may be coupled to the IC chip 102 to form the hybrid system 100. As discussed above in Section I, according to one embodiment the microfluidic system 300 may be configured as a relatively simple chamber or reservoir for holding liquids containing samples of interest. For example, as illustrated generically in FIGS. 1 and 2, a microfluidic reservoir having an essentially rectangular volume may include access conduits 302 and 304 to facilitate fluid flow into and out of the reservoir. Alternatively, the microfluidic system may have a more complex arrangement including multiple conduits or channels in which liquids containing samples may flow, as well as various components (e.g., valves, mixers) for directing flow. In various embodiments, the microfluidic system 300 may be fabricated on top of an IC chip 102 containing other system components, once the semiconductor fabrication processes are completed, to form the hybrid system 100; alternatively, the microfluidic system 300 may be fabricated separately (e.g., using soft lithography techniques) and subsequently attached to one or more IC chips containing other system components to form the hybrid system 100.

In other aspects of the embodiment shown in FIG. 1, the electric and/or magnetic field-generating components 200 of the hybrid system 100 may be disposed with respect to the microfluidic system 300 in a variety of arrangements so as to facilitate interactions between generated fields and samples contained in (or flowing through) the microfluidic system. In various implementations, the field-generating components 200 may be disposed proximate to the microfluidic system along one or more physical boundaries of the microfluidic system and arranged so as to permit field-sample interactions along one or more spatial dimensions relative to the microfluidic system. In general, according to the various concepts discussed herein, samples of interest may be moved through the microfluidic system along virtually any path, trapped or held at a particular location, and in some cases rotated, under computer control of the electric and/or magnetic fields generated by the field-generating components 200. In this manner, the topology of a “virtual micro-scale plumbing system” for samples of interest may be flexibly changed for a wide variety of operations based on the programmability and computer control afforded, for example, by the processor(s) 600. This provides an extremely powerful tool for precision cell/object manipulation in both relatively simple and more sophisticated operations.

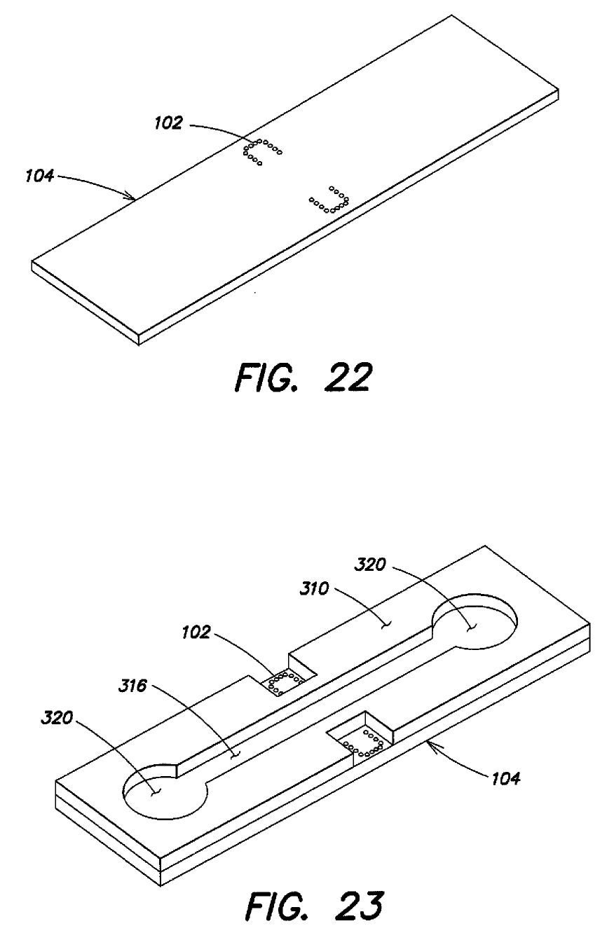

Generally, the top layer of an CMOS chip includes a silicon nitride or polyimide passivation layer, whose purpose is to prevent chemical elements such as sodium from penetrating into the chip. According to one embodiment, a microfluidic system 300 may be further fabricated on the top of the CMOS chip passivation layer, wherein the microfluidic system includes micropatterned polyimide sidewalls in desired shapes so as to form channels, or “mini canals,” to guide samples. FIGS. 22-26 illustrate various process steps involved in fabricating a polyimide-based microfluidic system as part of a hybrid system according to one embodiment of the present disclosure.

In particular, FIG. 22 shows a portion of a semiconductor substrate 104 including a single chip 102. In one aspect, the portion of the substrate 104 illustrated in FIG. 22 has been diced from a larger semiconductor wafer in which have been fabricated multiple chips 102; in one exemplary implementation, each chip 102 has dimensions on the order of 2 millimeters by 5 millimeters, and the wafer substrate may be diced into portions having dimensions on the order of 15 millimeters by 25 millimeters.

Once diced, the respective substrate portions 104 each including a single chip 102 may be spin-coated with polyimide and then patterned using conventional lithography techniques. Since the CMOS chip surface layer generally includes a polyimide passivation layer, micropatterned polyimide sidewalls can be fabricated with good adhesion to the similar-material passivation layer. FIG. 23 illustrates an example of a polyimide layer 310 on top of the substrate 104, wherein the polyimide layer includes a fluidic channel 316 and two portholes 320 patterned using conventional lithography techniques. In various exemplary implementations, the coating and patterning process for the polyimide layer may be configured to form a height and width for the fluidic channel 316 in a range from a few microns to a few thousands of microns depending on the requirements of a given application.

After the fabrication of the fluidic channel 316 in the polyimide layer 310, according to one embodiment the surface of the fluidic channel may be optionally coated (e.g., spin-coated) with a thin layer of polydimethylsiloxane, or PDMS. PDMS is a biocompatible material whose surface can be functionalized to either encourage or prevent cell adhesion. For example, in one aspect of this embodiment, treating the oxidized surface of polymerized PDMS with Fibronectin (FN) makes it amenable to micro-patterning of extracellular matrix proteins to facilitate cell adhesion and spreading. In another aspect, treating the surface of PDMS with Pluronic F127 can block protein absorption, thus preventing the adhesion of cells. These respective characteristics may facilitate different aspects of guiding biological samples down the microfluidic channels of a cell sorter according to one embodiment of the present disclosure (discussed further below in Section VI), and for directing the cells to specific locations during two-dimensional micro-scale tissue assembly according to another embodiment of the present disclosure (also discussed further below in Section VII). In various implementations, PDMS may be spin-coated to micron-thickness layers onto the surface of the fluidic channel, without compromising sample manipulation or imaging.

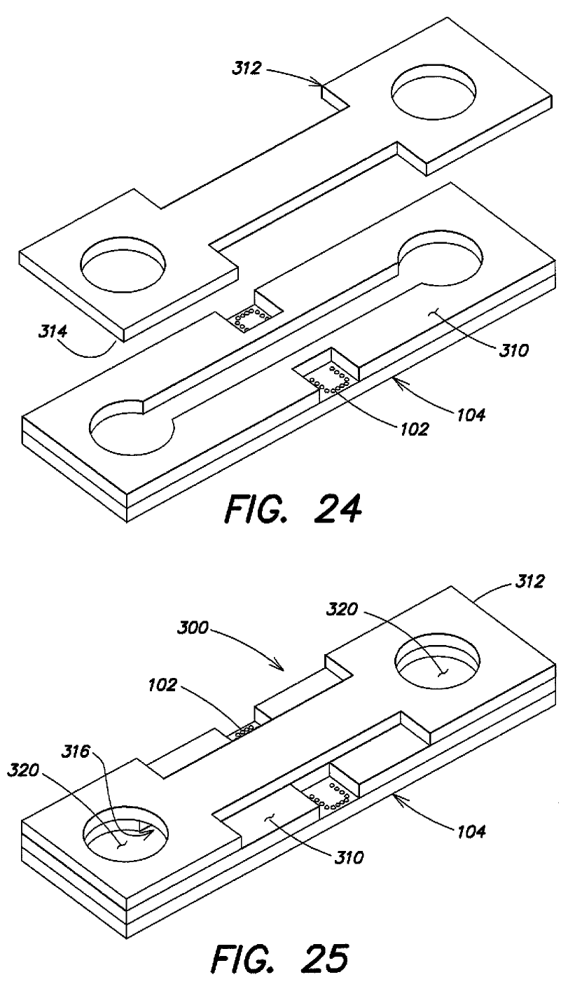

As illustrated in FIG. 24, an appropriately shaped cover slip 312 (e.g., a glass cover slip) may be coupled to the polyimide layer 310 to form a microfluidic chamber or channel. In one aspect, the surface of the cover slip to be joined to the polyimide layer may be coated with a negative photoresist or ultraviolet curable epoxy 314 (e.g., SU-8, available from Microchem, Inc. of Newton, Mass.) to facilitate a seal between the cover slip and the polyimide layer (e.g., via curing of the assembly with ultraviolet light). FIG. 25 illustrates the completed assembly of the cover slip 312 attached to the polyimide layer 312 so as to enclose the fluidic channel 316 and hence form the microfluidic system 300.

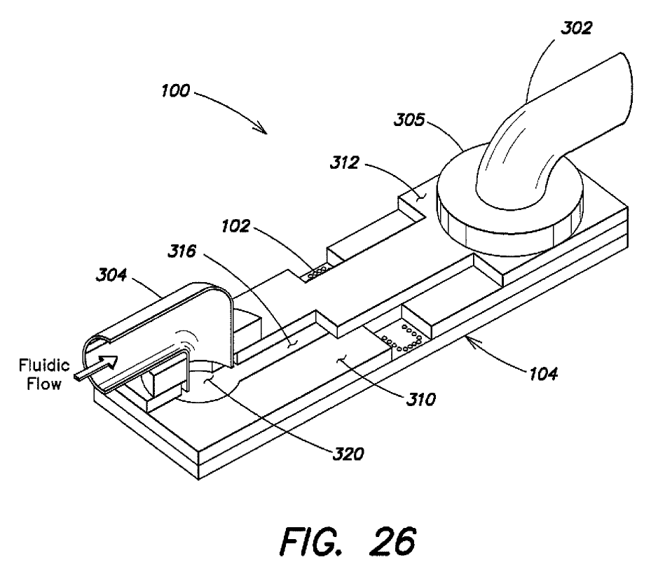

Finally, as illustrated in FIG. 26, access conduits 302 and 304 are coupled to the portholes 320 of the assembly via tube fittings 305 to complete the microfluidic system 300. In one implementation, a UV curable photoresist or epoxy again may be used to bond the tube fittings and conduits to the assembly. In FIG. 26, a portion of the conduit 304 is cut away in cross-section to illustrate the flow of fluid through the microfluidic system of the hybrid system 100.

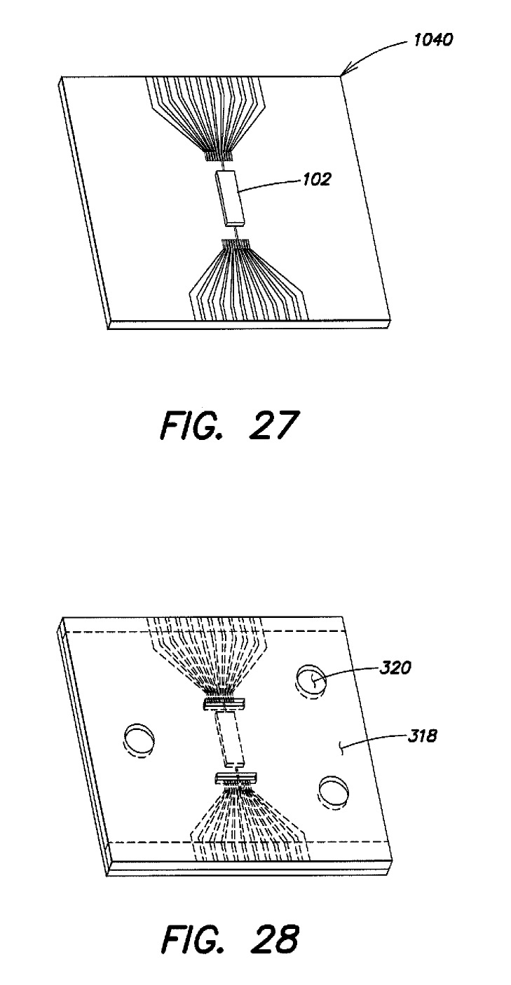

FIGS. 27-32 illustrate various process steps involved in fabricating the microfluidic system 300 based on patterning of ultraviolet curable epoxy, according to another embodiment of the present disclosure. In this embodiment, with reference first to FIG. 27, an individual IC chip 102 (e.g., having a dimension on the order of approximately 2 millimeters by 5 millimeters, with a thickness of approximately 270 micrometers) is glued to a silicon substrate 1040 that is different from the substrate from which the IC chip was fabricated. Stated differently, in this embodiment, IC chips are diced from a larger wafer in which they were fabricated to a size that is essentially equal to their fabrication footprint in the wafer (i.e., no extra substrate surrounding the area of the chip). Chips diced in this manner are then adhered to another larger silicon substrate 1040 (e.g., having a dimension on the order of 25 millimeters by 25 millimeters), wherein the larger substrate may include electrodes fabricated thereon to facilitate electrical connections to the IC chip. In one aspect, the substrate 1040 may serve as the hybrid system's package substrate 110 (see FIG. 2).

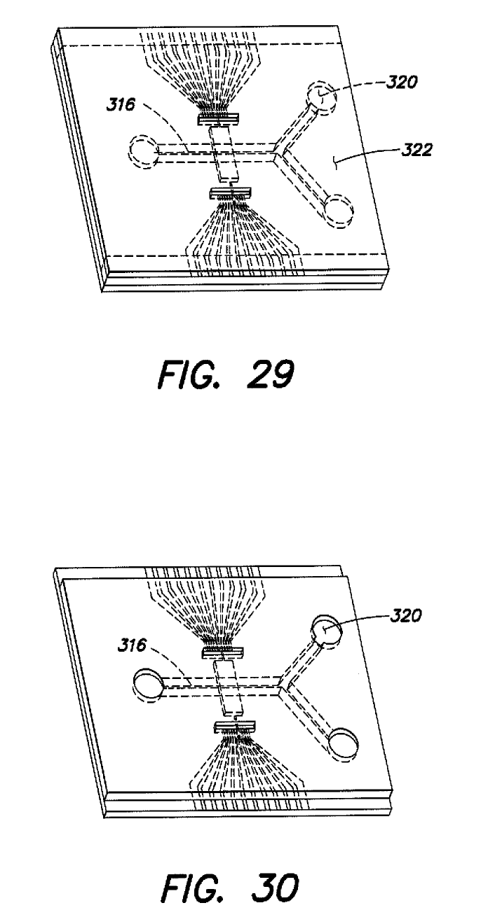

As illustrated in FIG. 28, in this embodiment the assembly of the IC chip 102 and substrate 1040 then are spin-coated with a first layer 318 of ultraviolet curable epoxy (e.g., SU-8) to a thickness that is slightly thicker than the thickness of the IC chip 102 (e.g., approximately 300 micrometers). Via conventional optical lithography techniques, a number of portholes 320 are patterned in the first layer, and the patterned layer is baked (e.g., a post-exposure bake at 95 Celsius for 30 minutes) but not developed. Subsequently, as shown in FIG. 29, a second layer 322 of ultraviolet curable epoxy is spin-coated (e.g., to a thickness of approximately 100 micrometers) and patterned by optical lithography to form the sidewalls of the fluidic channel 316 and the portholes 320. As with the first layer 318, the second layer 322 is post-exposure baked, and then the second layer is developed to form the fluidic channel 316. The development of the second layer exposes the porthole patterns of the first layer 318, which is then also developed to complete the formation of the portholes 320, as shown in FIG. 30.

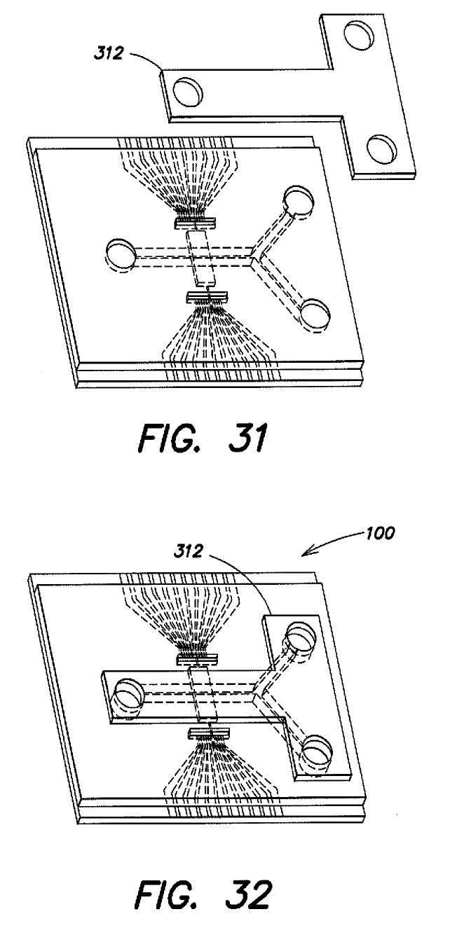

Next, as illustrated in FIG. 31, a glass or plastic cover slip 312 is coated with a thin (e.g., 50 micrometer) layer of ultraviolet curable epoxy, cut into an appropriate shape, and placed on top of the patterned assemble. The assembled hybrid system 100 (minus the access conduits), as shown in FIG. 32, is heated at 75 Celsius for approximately 10 minutes to soften the epoxy coated on the cover slip 312 and seal gaps at the junction of the cover slip and the second epoxy layer. Subsequently, the assembled device is blank-exposed with ultraviolet light and post-exposure baked to cure the bonding between the cover slip and the fluidic channel sidewalls. Access conduits then are connected to the assembly in a manner similar to that discussed above in connection with FIG. 26.

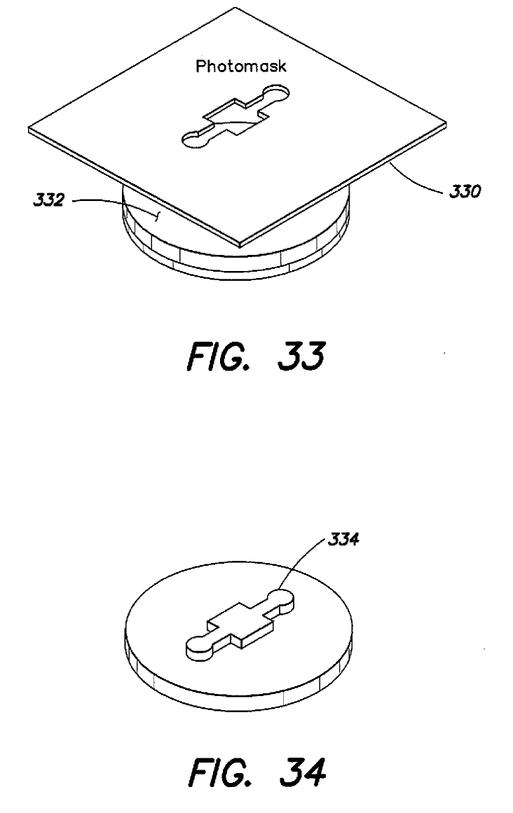

According to another embodiment, the hybrid system 100 shown in FIGS. 1 and 2 may be implemented by fabricating the microfluidic system 300 separately using PDMS and soft lithography techniques, and subsequently attaching the microfluidic system to the IC chip 102 (details of soft lithography techniques suitable for this embodiment are discussed in the references entitled “Soft Lithography,” by Younan Xia and George M. Whitesides, published in the Annual Review of Material Science, 1998, Vol. 28, pages 153-184, and “Soft Lithography in Biology and Biochemistry,” by George M. Whitesides, Emanuele Ostuni, Shuichi Takayama, Xingyu Jiang and Donald E. Ingber, published in the Annual Review of Biomedical Engineering, 2001, Vol. 3, pages 335-373; each of these references is incorporated herein by reference). FIGS. 33-38 illustrate various process steps involved in fabricating the microfluidic system 300 based on such soft lithography techniques.

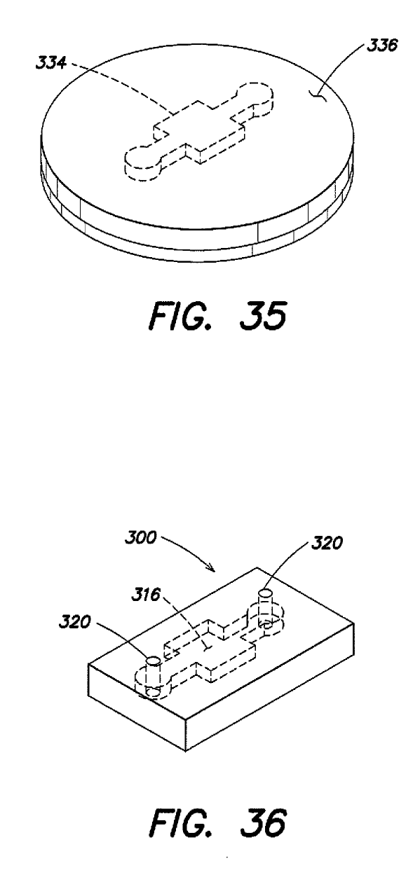

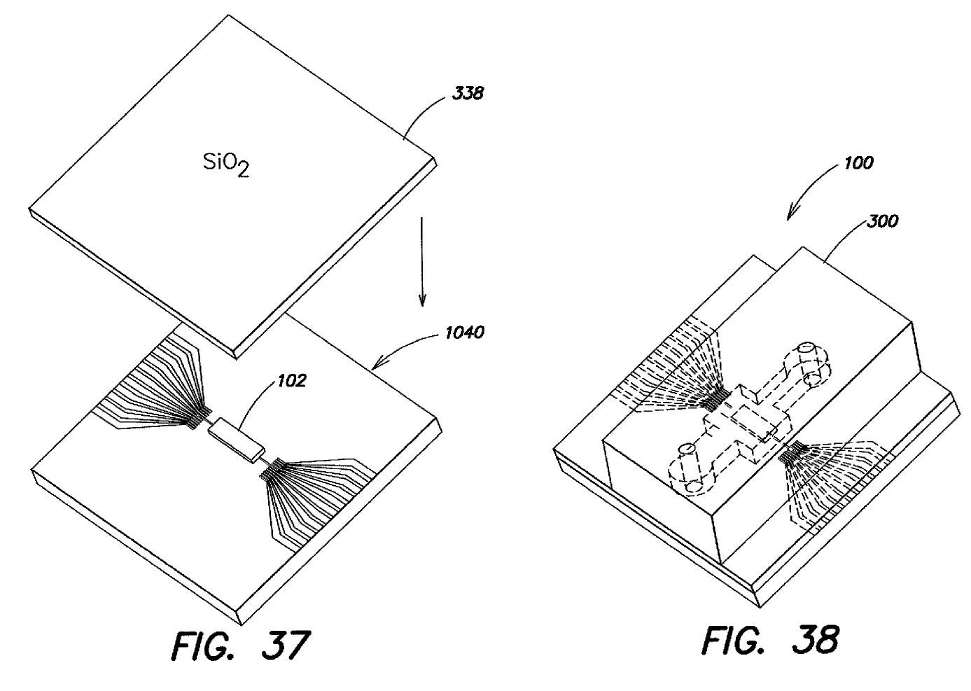

As shown in FIGS. 33 and 34, a silicon substrate is spin-coated with an ultraviolet curable epoxy 332 and patterned using a photomask 330 via conventional optical lithography techniques to produce a fluidic channel mold 334. In FIG. 35, a PDMS layer 336 is cast-coated on the mold and heat-cured. As shown in FIG. 36, the cured PDMS layer is then peeled off the mold, with the impression of a fluidic channel 316 formed therein. The PDMS layer is cut into a desired shape, and bored with portholes 320 to form the microfluidic system 300. In FIG. 37, a substrate 1040 to which an IC chip 102 has been attached is coated with a thin (e.g., 50 to 100 nanometers) layer 338 of Silicon Dioxide to promote bonding between the chip/substrate assembly and the PDMS microfluidic system 300. The surfaces to be bonded of the PDMS microfluidic system 300 and the chip/substrate assembly are treated with an oxygen plasma to “activate” the surfaces for bonding upon the application of pressure, and in FIG. 38 the activated surfaces are bonded together to form the hybrid system 100 (minus the access conduits).

In sum, according to various embodiments discussed above, an overall fabrication process for a CMOS/microfluidic hybrid system may include the following steps, in an appropriate order depending on the particular technique used: 1) silicon foundry fabrication of CMOS chip including microcoil array, digital switching network, imaging (e.g. RF) electronics and related circuitry, and temperature regulation electronics; 2) optional Permalloy deposition in appropriate microcoils to increase magnetic field strength; 3) fabrication of the microfluidic system (e.g., either on the chip directly via polyimide-based or ultraviolet epoxy-based techniques or separately with soft lithography PDMS mold); 4) PDMS coating of the CMOS chip surface with various agents for biocompatibility; 5) application of cover slip to from fluidic channel(s)/chamber; and 6) assembly of the CMOS/microfluidic hybrid system with an electrical board (e.g., package substrate) and a temperature controller (e.g., thermoelectric cooler).

VI. Sample Counting and Sorting

According to another embodiment, a hybrid system 100 including sample detection and imaging components as discussed above in Section III, and various configurations of a microfluidic system as discussed above in Section V, may be employed in a number of cell counting, sorting and identification applications.

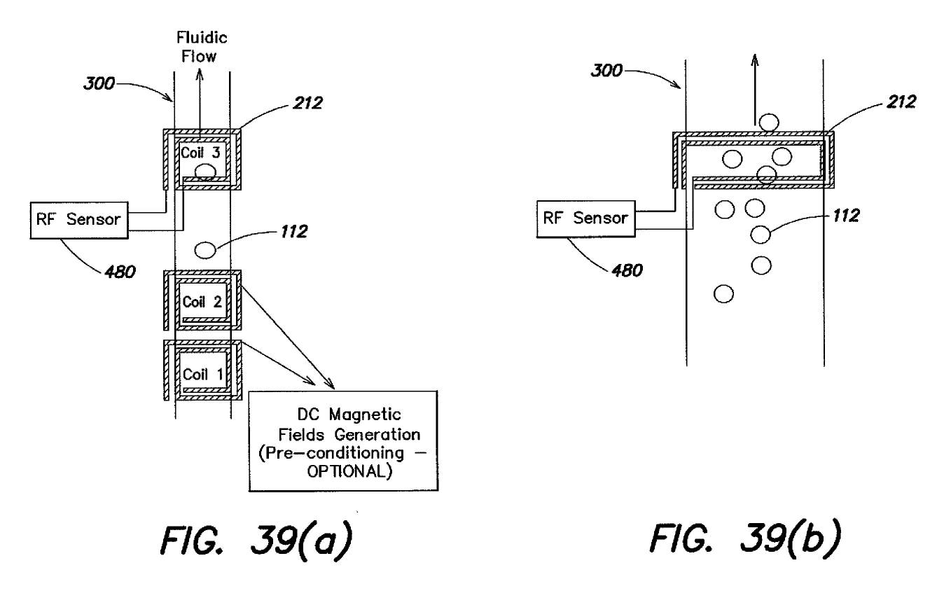

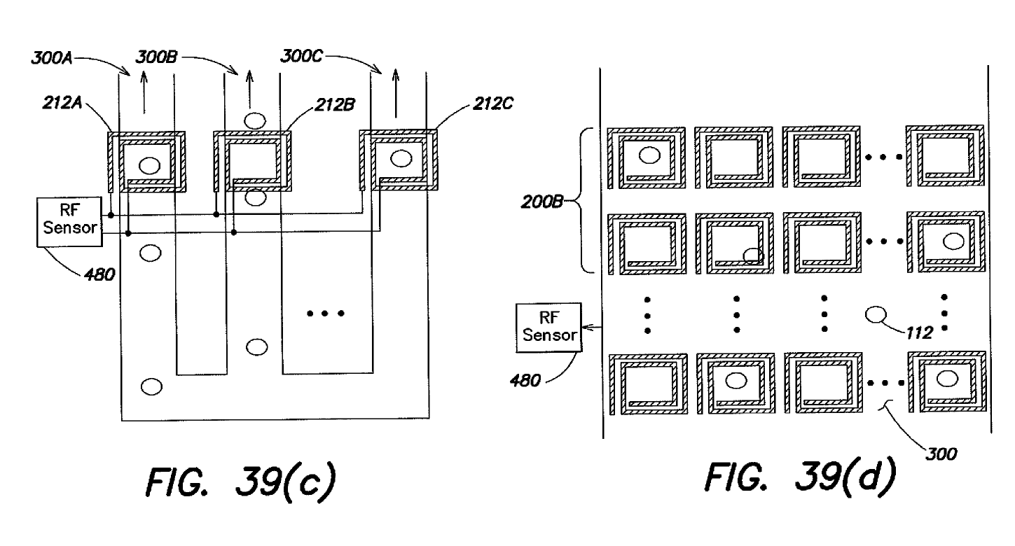

For example, FIGS. 39(a)-(d) illustrate various exemplary implementations of cell detection via RF sensing techniques as discussed above in connection with FIGS. 17-20. In FIG. 39(a), a single narrow microfluidic channel may allow only one bead-bound sample to pass over a given microcoil at a time (i.e., a fluid suspension contains magnetic beads 112 bound to samples of interest flowing through the channel 300 over a microcoil 212 (Coil 3) coupled to RF/detection components 480, which senses the magnetic beads individually). Cell counting may be accomplished based on varying fluid flow rates and characteristics of the magnetic beads suspended in the fluid. In some cases, if the fluid flows too fast, the magnetic bead may not have enough time to magnetize in the sensing coil (Coil 3) and hence may not be appropriately detected by the RF/detection components 480. In such cases, other microcoils in the linear microcoil array shown in FIG. 39(a) may be employed (e.g., Coils 1 and 2 in addition to Coil 3) to generate DC magnetic fields to magnetize beads before their arrival to the sensing coil (Coil 3), thereby facilitating detection of the beads.

In another example, as shown in FIG. 39(b), a wide microfluidic channel 300 may be implemented that passes several beads 112 at a time over a single microcoil 212 coupled to the RF/detection components 480, during which the microcoil 212 can sense multiple beads simultaneously with the counting resolution of one bead. Other counting examples are given in FIG. 39(c), in which multiplexed fluidic channels 300A, 300B and 300C are employed, and in FIG. 39(d), which illustrates two-dimensional imaging of a magnetic bead distribution via a microcoil array 200B and a single reservoir microfluidic system 300. As discussed above, with RF/detection components 480 capable of exciting each microcoil of a two-dimensional array, the microcoil array 200B is analogous to the pixel arrangement of a conventional CCD imaging system.

Another embodiment according to the present disclosure is directed to precision cell sorting methods and apparatus based on a CMOS/microfluidic hybrid system including RF/detection components, pursuant to various embodiments discussed above. Isolating a homogeneous cell population with high accuracy from a dissoluted organ or tissue or from batches of pooled blood is important for conducting gene expression analysis, for cell and tissue engineering assays requiring a pure cell line, or for clinical applications (e.g., stem cell separation for bone marrow reconstitution procedures in cancer patients.). Many cells can be recognized due to the expression of unique cell surface receptors. In conventional approaches, magnetic beads coated with the ligand for these receptors have been used to engage the cells with magnetic tweezers and magnetic twisting cytometry. This technique has been used for cell sorting/separation as well, but the conventional magnetic separation technique employs a simple stationary magnet that statistically sorts a large group of bead-bound cells all at once, lacking controllability and precision. In contrast to conventional approaches, one embodiment of the present disclosure combines the high controllability of CMOS electronics with micro-scale manipulation and detection capabilities of the microcoil array to realize ultra-precise, high-throughput, and automated cell sorting methods and apparatus for individual biological cells attached to magnetic beads within heterogeneous suspensions.

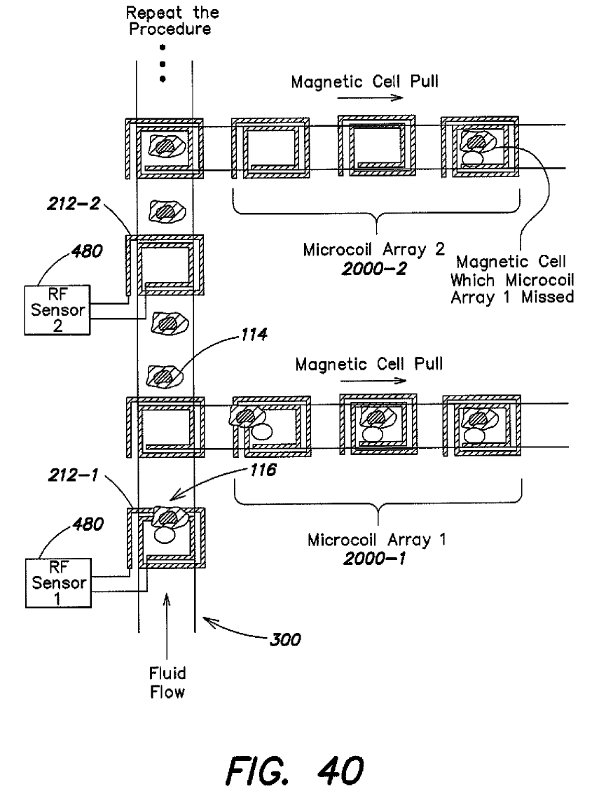

In one exemplary implementation of this embodiment, as illustrated in FIG. 40, a solution of cells including both bead-bound cells 116 and non-magnetized cells 114 are suspended in a fluid that flows through the microfluidic channel 300 (e.g., in one exemplary implementation, capillary endothelial cells and NIH 3T3 fibroblasts may be suspended in media with 2.8 micrometer magnetic beads coated with the antibody to platelet endothelial cell adhesion molecule (PECAM), a cell surface receptor exclusive to endothelial cells; ligand-coated beads attach to endothelial cells only). The microfluidic channel passes over an RF sensor 212-1 or 212-2 (i.e., a microcoil coupled to RF/detection components 480), and whenever a bead-bound cell 116 passes over the sensor, the sensor registers and counts the bead-bound cell. In one aspect of the embodiment shown in FIG. 40, whenever the first RF sensor 212-1 detects a bead-bound cell 116, the microcoils in the first linear microcoil array 2000-1 activate sequentially to pull the bead-bound cell 116 like a “conveyor belt,” thereby removing it from the combined cell fluid flow and effectively separating bead-bound cells from the general cell population. In one implementation, the linear microcoil array 2000-1 need not always be on, so as to minimize power consumption, and may be turned on with a signal of the preceding RF sensor 212-1 indicating the presence of a bead-bound cell 116.

In FIG. 40, in some cases some bead-bound cells 116 might pass the first linear microcoil array 2000-1 without being pulled out of the mainstream of flow. However, in one aspect of the embodiment of FIG. 40, multiple sensor-linear microcoil array blocks may be sequentially employed, each with the same operating protocol (e.g., note the microcoil 212-2 serving as a second “RF sensor” and the second linear microcoil array 2000-1). Such a redundant system with individual cell selection substantially increases cell sorting yield and accuracy without compromising speed. The RF sensors 212-1 and 212-2 quantitatively monitor sorting accuracy in real time by sensing the presence of magnetic bead-bound samples 116. After passing thru this system, the segregated bead-bound and unbound cells are respectively collected, with the unbound cell population available for further sorting by the same protocol to remove any bead-bound cells (presumably few) that may remain in this population.

The cell sorting methods and apparatus exemplified in the arrangement of FIG. 40 offer several important advantages over prior techniques. For example, in one aspect, individual bead-bound-cells may be separated from heterogeneous cell populations at a very low error rate, where accuracy is monitored quantitatively using RF/detection components in real time. Furthermore, the accuracy of the cell sorting methods and apparatus discussed in connection with FIG. 40 is much higher than that of the conventional magnetic separation techniques developed and used clinically to isolate specific blood cell types or pathogens from batches of pooled blood (e.g., stem cells for bone marrow reconstitution procedures in cancer patients.). In the conventional method, a large group of bead-bound cells are statistically pulled out of the remaining blood contents all at once using a tube filled with steel wool surrounded by a stationary magnet. This method is labor intensive and lacks accuracy, especially when a certain type of cells needs to be “completely” cleared.

Additionally, the cell sorting methods and apparatus discussed above facilitate parallel fluid processing with multiplexed microfluidic channels and CMOS circuits. CMOS electronics also makes possible automation in cell sorting. In comparison with fluorescence-activated cell sorters (FACS), a system according to the concepts discussed herein may be implemented in a much smaller and less expensive manner. Moreover, a cell sorting system according to the present disclosure requires minimal preparation of the cells for sorting (e.g., no transfection of fluorescent proteins). Additionally, in another aspect, it is arguably easier to maintain physiological homeostasis with a microfluidic system than any large volume device.

According to various aspects of the embodiment illustrated in FIG. 40, a number of practical considerations may influence the cell sorting process. For example, some variables that may affect cell sorting include, but are not necessarily limited to: 1) efficiency of ligand-receptor binding on targeted cells; 2) incidence of nonspecific binding of the beads to non-targeted cells; 3) the number of cell types in the solution; 4) the density, or cells per liter, of the suspension; and 5) the efficiency with which cells have been dissoluted from a harvested tissue or organ. The first and second variable may be addressed by selecting ligands that are specific to cell surface receptors uniquely expressed by the targeted cell type.

For example, by targeting endothelial cells in one exemplary implementation, PECAM is an ideal choice of cell surface molecules because of its unique expression in endothelial cells and because of its role in cell mobility and cellular adhesion; as a result, the likelihood of detachment of the bound magnetic bead during transit is reduced. In another implementation, endothelial cells may be sorted from a cell suspension also containing NIH 3T3 fibroblasts which do not express PECAM. The throughput rates and density of the cell suspensions may be calibrated for optimal sorting performance.

Also, in other implementations, an iterative process may be employed, wherein experimental parameters optimized in a first sorting process serve as the initial conditions for one or more subsequent sorting processes, such that cells may be sorted from suspensions containing multiple cell types. For example, in one process involving the neonatal heart, endothelial cells may be separated from cardiac myocytes, fibroblasts, immune cells that have extravasated prior to harvest, and neural tissue. The ‘noisy’ environment created by this mixed cell population in some cases determines the boundaries of cell sorting performance. In one aspect, diluting the cell suspension may increase the time required for sorting, but may increase sort accuracy. In another aspect, to assure sufficient dissolution, a suspension may be passed through a filter that selectively filters large cellular ensembles that have evaded dissolution by trypsin and collagenase.

VII. Tissue Assembly

In yet another embodiment according to the present disclosure, micro-scale assembly of engineered tissues may be realized using the various methods and apparatus discussed herein. For example, in one implementation, assembly of micro-scale, engineered cardiac tissues from heterotypic cell populations is accomplished utilizing a CMOS/microfluidic hybrid system 100 as discussed herein.

A complex signaling dialogue between multiple cell types in a tightly constrained space that is reorganizing with each developmental step mediates tissue morphogenesis. In the mature tissue, the spatial and demographic control of these cell populations is strenuously maintained but its loss marks the onset of the disease process in a recognizable fashion. What is unknown is how the subtle interactions of seemly controlled cell populations can potentiate pathogenic events. An excellent example of this is the cell-cell interactions between capillaries and cardiac muscle fibers in the heart, which alters action potential propagation, contributing to arrhythmogenesis. This is an important problem because there is currently no clinically reliable means of treating cardiac arrhythmias medicinally. Furthermore, antiarrhythmic drug pipelines at pharmaceutical and biotechnology companies are barren, in part due to a lack of experimental assays that support the identification of new drug targets. Thus, the ability to engineer micro-scale cardiac tissues of heterogeneous cell populations offers reliable, effective assays of cardiac arrhythmia for the discovery of new drug targets and the elucidation of answers to fundamental questions in cardiac electrophysiology.

More generally, heterotypic signaling between different cell populations defines the tissue micro-environmental changes in tumors, the heart, and liver. Therefore, micro-scale tissue assembly is important to study communication networks amongst different cell types, drug efficacy, and for fundamental physiological study in a standardized, repeatable manner. However, precise engineering of model tissues on micro-scale has proven difficult.

Several techniques for heterotypic cell culture with population control exist. Transwell plates have traditionally been used to study paracine signaling between two distinct cell populations. New techniques for mimicking the tissue microenvironment in vitro have relied on photolithographic techniques. One known strategy is based on using patterned photoresists or masks to allow cell attachment to select regions of a surface. Subsequent removal of the resist or mask reveals areas amenable to a second cell type's adhesion. A second strategy exploits dielectrophoresis to pattern and separate cervical carcinoma cells from red and white blood cells on a microelectrode array. Other strategies include microfluidic channels to direct cell suspensions to different locations on a surface, an electroactive mask that allows seeding of a second cell type to regions of a surface that were electrically activated to permit attachment, and gravity-enforced tissue assembly. These techniques have proven to be labor intensive, lacking precise population control, and slow. The technique based on dielectrophoresis is interesting, because it represents a strategy for cell sorting and micro-scale tissue reconstruction; however, it lacks the accurate cell population control required to do quantitative studies, the spatial control afforded by micropatterning technologies, and is reliant upon the cells having distinct polarizabilities for effective trapping and patterning. This prevents the guarantee of homogeneous cell populations, which can be assured only through molecular specificity.

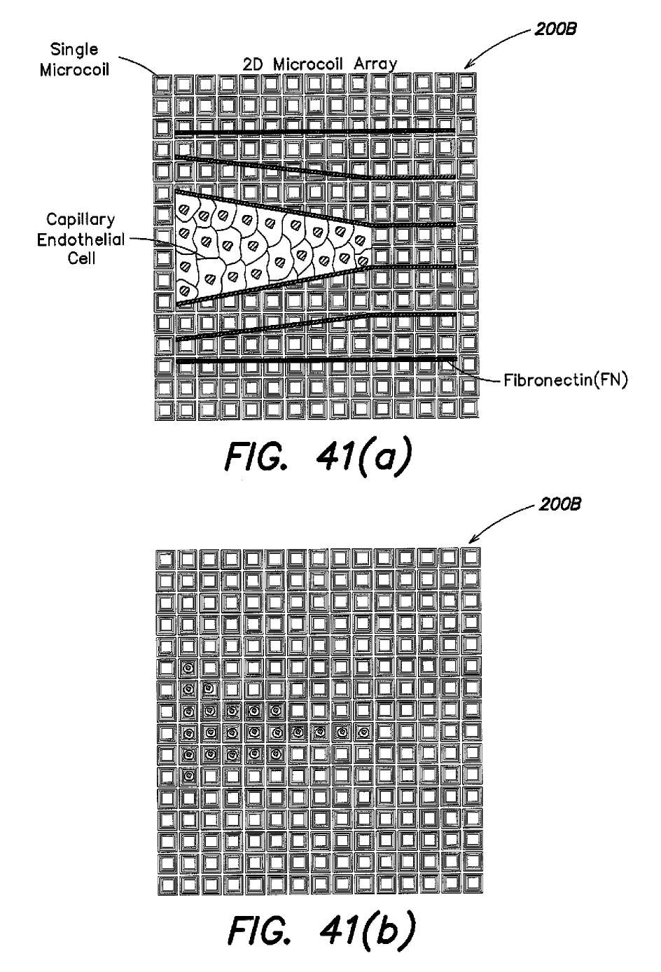

In view of the foregoing, one embodiment according to the present disclosure is directed to the assembly of a two-dimensional tissue, as illustrated in FIGS. 41-43. In one exemplary implementation, capillary endothelial cells are considered, wherein the cells are assembled by coating magnetic beads with antibodies to PECAM and suspending the beads in solution with the dissociated endothelial cells. As shown in FIG. 41, cells that are attached to the beads can be separated and then guided into formation over a Fibronectin (FN)-coated chip surface using the microcoil array 202B of an IC chip 102. In particular, as shown in FIG. 41(a), a two-dimensional endothelial cell layer is precisely assembled using the microcoil array 200B, wherein micropatterned Fibronectin (FN) is shown with thick black lines. In FIG. 41(b), endothelial cells occupy those regions indicated by darkened microcoils, which have non-zero DC currents thereby creating magnetic fields. Once in position, the cells are allowed to adhere and spread on the chip surface, forming a confluent monolayer of defined geometry.

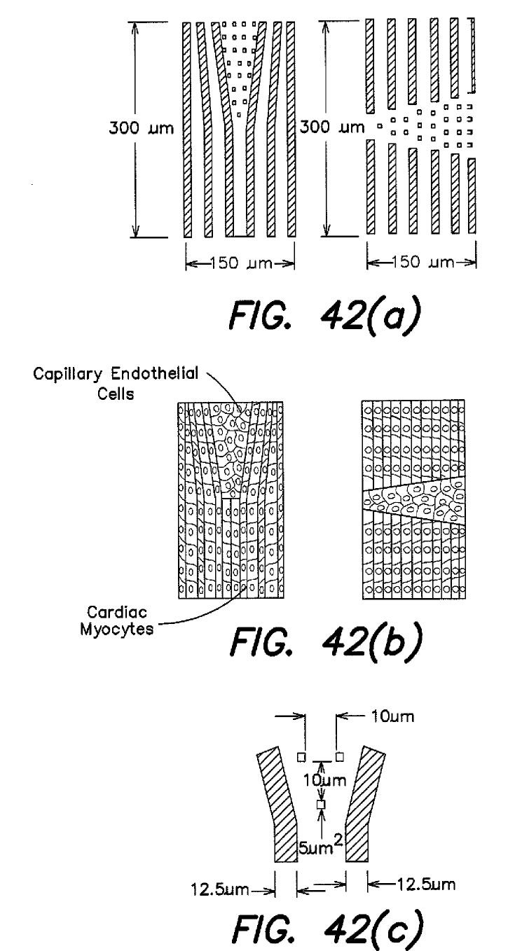

Subsequently, this endothelial tissue is assembled as an “embedded tissue” within a preexisting cardiac muscle tissue. In one embodiment, two-dimensional cardiac tissues may be built by culturing neonatal rat ventricular myocytes on micropatterned Fibronectin. Dissociated cardiac myocytes are cultured in micropatterned FN lines, as shown in FIG. 42(a). The cardiac myocytes adhere to and align with the FN lines, self-assembling into a confluent, anisotropic monolayer that is capable of conducting action potential wavefronts. FIG. 42(b) shows the cardiac tissue constructs, simulating a capillary parallel (top) and perpendicular (bottom) to the cardiac fibers. FIG. 42(c) shows the spacing of focal-adhesion sized FN islands.

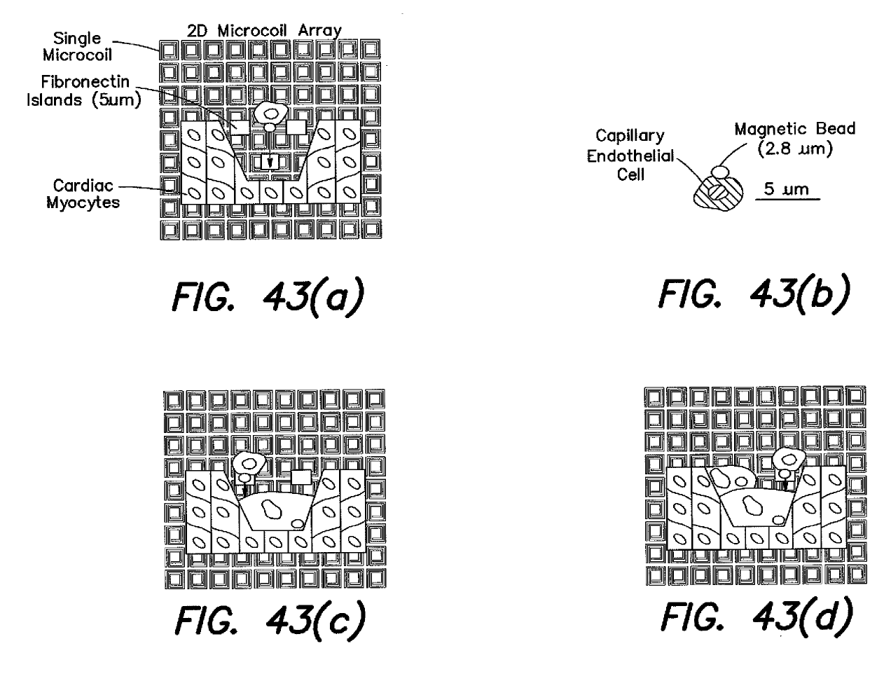

Using the microcoil array, capillary endothelial cells may be embedded in precise formations relative to the fiber orientation of the engineered cardiac tissue, as shown in FIG. 43. In FIG. 43(a), capillary endothelial cells marked by magnetic beads (see FIG. 43(b)) are guided into position amongst previously cultured cardiac myocytes using the microcoil array. When in the appropriate position, they are held long enough for integrin attachment to the micropatterned FN. As shown in FIGS. 43(c) and (d), the endothelial cell binds the FN and extends lamellipodia to attach to other islands and the edges of the FN lines upon which cardiac myocytes are attached.

The small, focal adhesion-sized FN islands may not be amenable to myocyte adhesion and spreading because the spontaneous contraction of these myocytes tears them from a single, small FN island before they can sufficiently adhere. However, capillary endothelial cells bind these islands and extend lamellipodia to spread to occupy several simultaneously. Thus, regions that are micropatterned with small FN islands are capable of selectively hosting endothelial cells but not cardiac myocytes (See FIG. 42). Endothelial cells attached to magnetic beads are added one at a time by the microcoil array as shown in FIG. 43, because putting them in solution after the myocytes have adhered to the substrate may lead to mixed, uncontrolled populations along the micropatterned FN lines. The constructed endothelial embeds are allowed to spread in culture for 24 hours or less. Immunohistochemistry may be used to mark the cells to track their growth at specific time points after the microcoil array-based construction. Specifically, the tissues may be triple-stained for sarcomeric α-actinin, PECAM, and nuclear DNA (DAPI) in order to precisely locate the demarcation line between the endothelial cells and the cardiac myocytes, as well as to check for possible migration and proliferation of the endothelial cells. In one aspect, the refined media conditions minimize endothelial cell proliferation but support endothelial cells spreading and myocyte beating.

According to the foregoing methodology, uniformity and geometric precision of the endothelial cell embed, as well as preventing the invasion of endothelial cells amongst the cardiac muscle fibers, may be accomplished. Applicants have recognized and appreciated that prepositioning of the cardiac myocytes on the micropatterned surface prior to the assembly of the endothelial embed is an important step in the process. In particular, cardiac myocytes require more time to attach and conform to extracellular matrix cues than other cell types. Additionally, capillary endothelial cells are quite migratory, whereas the cardiac myocytes are not. Thus, by prepositioning the cardiac myocytes, the cells of the endothelial embed may be effectively contained to their designated regions after assembly.

### CONCLUSION

Various embodiments of a hybrid system as discussed herein incorporate elements of electromagnetics, microfluidics, semiconductor physics, lithographic techniques, high frequency (e.g., RF) electronics, analog/digital integrated circuits, feedback control and biology in a complementary system. In various exemplary implementations, such a hybrid system may be configured as a “biochip,” providing a versatile programmable device that can perform a wide range of biological experiments on a submicron scale, and thereby significantly benefit “lab-on-a-chip” development of industrial, scientific and military interests.

Having thus described several illustrative embodiments, it is to be appreciated that various alterations, modifications, and improvements will readily occur to those skilled in the art. Such alterations, modifications, and improvements are intended to be part of this disclosure, and are intended to be within the spirit and scope of this disclosure. While some examples presented herein involve specific combinations of functions or structural elements, it should be understood that those functions and elements may be combined in other ways according to the present invention to accomplish the same or different objectives. In particular, acts, elements, and features discussed in connection with one embodiment are not intended to be excluded from similar or other roles in other embodiments. Accordingly, the foregoing description and attached drawings are by way of example only, and are not intended to be limiting.

1. An apparatus, comprising:
a plurality of CMOS fabricated field-generating components;
a microfluidic system configured to contain a fluid in proximity to the plurality of CMOS fabricated field-generating components; and
at least one controller configured to control the plurality of CMOS fabricated field-generating components to generate at least one electric or magnetic field having a sufficient strength to interact with at least one sample suspended in the fluid.

2. The apparatus of claim 1, wherein the at least one controller is configured to control the plurality of CMOS fabricated field-generating components to generate a plurality of programmable spatially or temporally variable electric or magnetic fields having a sufficient strength to interact with the at least one sample suspended in the fluid.

3. The apparatus of claim 2, further comprising at least one processor coupled to the at least one controller, the at least one processor configured to control the at least one controller so as to facilitate at least one of manipulation, detection, imaging and characterization of the at least one sample via the plurality of electric or magnetic fields.

4. The apparatus of claim 3, wherein the at least one processor is configured to facilitate programmable automated manipulation of the at least one sample based on detection of the at least one sample.

5. The apparatus of claim 1, wherein the at least one controller includes a plurality of CMOS fabricated field control components forming an integrated circuit chip together with the plurality of CMOS fabricated field-generating components.

6. The apparatus of claim 5, wherein the microfluidic system is coupled integrally with the integrated circuit chip to form a CMOS/microfluidic hybrid system.

7. The apparatus of claim 6, wherein the microfluidic system includes at least one polyimide layer, disposed above the CMOS fabricated field-generating components, in which at least one microfluidic channel or reservoir is formed.

8. The apparatus of claim 6, wherein the microfluidic system includes at least one epoxy layer, disposed above the CMOS fabricated field-generating components, in which at least one microfluidic channel or reservoir is formed.

9. The apparatus of claim 6, wherein the microfluidic system includes at least one polydimethylsiloxane (PDMS) mold, disposed above the CMOS fabricated field-generating components, in which at least one microfluidic channel or reservoir is formed.

10. The apparatus of claim 5, wherein the plurality of field control components includes:
a plurality of programmable switching or multiplexing components; and
a plurality of current or voltage sources.

11. The apparatus of claim 10, wherein the plurality of field control components further includes a plurality of high frequency detection components configured to facilitate at least one of detection, imaging and characterization of the at least one sample suspended in the fluid via the generated at least one electric or magnetic field.

12. The apparatus of claim 11, further comprising at least one CMOS fabricated temperature regulation component forming the integrated circuit chip together with the plurality of CMOS fabricated field control components and the plurality of CMOS fabricated field-generating components.

13. The apparatus of claim 12, further comprising at least one processor coupled to the at least one controller, the at least one processor configured to control the at least one controller so as to facilitate at least one of manipulation, detection, imaging and characterization of the at least one sample via the generated at least one electric or magnetic field.

14. The apparatus of claim 13, wherein the at least one processor is configured to facilitate programmable automated manipulation of the at least one sample based on detection of the at least one sample.

15. The apparatus of claim 1, wherein the plurality of CMOS fabricated field-generating components includes a plurality of microcoils.

16. The apparatus of claim 15, wherein the plurality of microcoils are arranged as a two-dimensional array.

17. The apparatus of claim 15, wherein each microcoil includes at least two axially concentric spatially separated portions of conductor turns.

18. The apparatus of claim 15, wherein the at least one controller includes a plurality of switching or multiplexing components and a plurality of current or voltage sources coupled to the plurality of microcoils.

19. The apparatus of claim 18, wherein the at least one controller further includes a plurality of radio frequency (RF) detection components coupled to the plurality of microcoils.

20. The apparatus of claim 19, wherein the plurality of RF detection components includes a frequency locked loop configured to facilitate at least one of detection, imaging and characterization of the at least one sample suspended in the fluid.

21. The apparatus of claim 20, wherein the frequency locked loop includes at least one bridge circuit, the at least one bridge circuit including at least one microcoil of the plurality of microcoils, the at least one bridge circuit configured to generate at least one signal representing a change in an inductance of the at least one microcoil due to a presence of the at least one sample in proximity to the at least one microcoil.

22. A method, comprising an act of:
A) generating at least one electric of magnetic field from a plurality of CMOS fabricated field-generating components, the at least one electric or magnetic field having a sufficient strength to interact with at least one sample suspended in a fluid contained in a microfluidic system in proximity to the plurality of CMOS fabricated field-generating components.

23. The method of claim 22, wherein the act A) includes an act of:
A1) generating a plurality of programmable spatially or temporally variable electric or magnetic fields having a sufficient strength to interact with the at least one sample suspended in the fluid.

24. The method of claim 23, further comprising an act of:
B) controlling the plurality of electric or magnetic fields so as to facilitate at least one of manipulation, detection, imaging and characterization of the at least one sample.

25. The method of claim 24, wherein the act B) comprises an act of:
controlling the plurality of electric or magnetic fields so as to facilitate automated manipulation of the at least one sample based on detection of the at least one sample.

26. The method of claim 24, wherein the act A1) comprises an act of:
applying a voltage or current to the plurality of CMOS fabricated field-generation components via a plurality of programmable switching or multiplexing components.

27. The method of claim 24, wherein the act A1) comprises an act of:
A2) applying at least one high frequency signal to at least one field-generation component of the plurality of CMOS fabricated field-generation components to facilitate at least one of detection, imaging and characterization of the at least one sample.

28. The method of claim 27, wherein the act A2) comprises an act of:
monitoring a frequency of the at least one high frequency signal, wherein the frequency indicates the presence or absence of the at least one sample in proximity to the at least one field-generation component.

29. The method of claim 27, further comprising an act of:
C) regulating a temperature of the at least one sample.

30. The method of claim 22, wherein the plurality of CMOS fabricated field-generating components includes a plurality of microcoils, each microcoil including at least two axially concentric spatially separated portions of conductor turns.
